(19) United States
(12) Patent Application Publication
(10) Pub. No.: US 2024/0171352 A1
(43) Pub. Date: May 23, 2024

(54) GUARD PERIODS FOR SOUNDING REFERENCE SIGNAL RESOURCE SETS

(71) Applicant: QUALCOMM INCORPORATED, San Diego, CA (US)

(72) Inventors: Runxin Wang, San Diego, CA (US); Muhammad Sayed Khairy Abdelghaffar, San Jose, CA (US); Yu Zhang, San Diego, CA (US); Alexandros Manolakos, Escondido, CA (US)

(21) Appl. No.: 18/550,861

(22) PCT Filed: May 4, 2021
(86) PCT No.: PCT/CN2021/091812

§ 371 Date: Sep. 15, 2023

(51) Int. Cl. H04L 5/00; H04W 24/08; H04W 72/0446

(52) U.S. Cl. CPC H04L 5/0051; H04W 24/08; H04W 72/0446

(57) ABSTRACT

Methods, systems, and devices for wireless communications are described. A user equipment (UE) may receive. from a base station, signaling that indicates an indirect assignment of a slot for transmitting sounding reference signals (SRSs) in multiple SRS resource sets. The UE may determine whether the slot is available for the indirect assignment based on a first set of characteristics associated with the multiple SRS resource sets and a second set of characteristics associated with the slot. If the UE determines that the slot is available for the indirect assignment, the UE may transmit SRSs in the multiple SRS resource sets during the slot. If the UE determines that the slot is unavailable for the indirect assignment. the UE may refrain from transmitting SRSs in one or more of the multiple SRS resource sets during the slot.

### CROSS REFERENCE

The present Application is a 371 national stage filing of International PCT Application No. PCT/CN2021/091812 by Wang et al. entitled “GUARD PERIODS FOR SOUNDING REFERENCE SIGNAL RESOURCE SETS,” filed May 4, 2021, which is assigned to the assignee hereof, and which is expressly incorporated by reference in its entirety herein.

### FIELD OF TECHNOLOGY

The following relates to wireless communications, including guard periods for sounding reference signal (SRS) resource sets.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a base station may configure a UE to transmit sounding reference signals (SRSs) in multiple SRS resource sets during a slot. In some cases, the multiple SRS resource sets may be configured with different antenna ports. Different slots may have different characteristics including uplink, downlink, mixed, or flexible resources within the slots. Managing SRS transmissions where multiple SRS resources sets are configured with varying slot characteristics may provide challenges in efficiency for communication of SRS.

### SUMMARY

The described techniques relate to improved methods, systems, devices, and apparatuses that support guard periods for sounding reference signal (SRS) resource sets. Generally, the described techniques provide for enabling a user equipment (UE) to selectively transmit SRSs in multiple SRS resource sets within a slot. The UE may receive, from a base station, signaling that indicates an indirect assignment of a slot for transmitting SRSs in multiple SRS resource sets. The UE may determine whether the slot is available for the indirect assignment based on a first set of characteristics associated with the multiple SRS resource sets and a second set of characteristics associated with the slot. If the UE determines that the slot is available for the indirect assignment, the UE may transmit SRSs in the multiple SRS resource sets during the slot. If the UE determines that the slot is unavailable for the indirect assignment, the UE may refrain from transmitting SRSs in one or more of the multiple SRS resource sets during the slot.

A method for wireless communications at a UE is described. The method may include receiving, from a base station, signaling indicating an indirect assignment of one or more slots for a set of multiple SRS resource sets, determining that a first slot of the one or more slots is available for the indirect assignment for at least a first SRS resource set of the set of multiple SRS resource sets based on first characteristics of the first SRS resource set and second characteristics of the first slot, and communicating with the base station in the first slot based on determining that the first slot is indicated for the indirect assignment.

An apparatus for wireless communications at a UE is described. The apparatus may include a processor, memory coupled with the processor, and instructions stored in the memory. The instructions may be executable by the processor to cause the apparatus to receive, from a base station, signaling indicating an indirect assignment of one or more slots for a set of multiple SRS resource sets, determine that a first slot of the one or more slots is available for the indirect assignment for at least a first SRS resource set of the set of multiple SRS resource sets based on first characteristics of the first SRS resource set and second characteristics of the first slot, and communicate with the base station in the first slot based on determining that the first slot is indicated for the indirect assignment.

Another apparatus for wireless communications at a UE is described. The apparatus may include means for receiving, from a base station, signaling indicating an indirect assignment of one or more slots for a set of multiple SRS resource sets, means for determining that a first slot of the one or more slots is available for the indirect assignment for at least a first SRS resource set of the set of multiple SRS resource sets based on first characteristics of the first SRS resource set and second characteristics of the first slot, and means for communicating with the base station in the first slot based on determining that the first slot is indicated for the indirect assignment.

A non-transitory computer-readable medium storing code for wireless communications at a UE is described. The code may include instructions executable by a processor to receive, from a base station, signaling indicating an indirect assignment of one or more slots for a set of multiple SRS resource sets, determine that a first slot of the one or more slots is available for the indirect assignment for at least a first SRS resource set of the set of multiple SRS resource sets based on first characteristics of the first SRS resource set and second characteristics of the first slot, and communicate with the base station in the first slot based on determining that the first slot is indicated for the indirect assignment.

In some examples of the method, apparatuses, and non-transitory computer-readable medium described herein, communicating with the base station in the first slot may include operations, features, means, or instructions for transmitting, in the first slot, a first SRS in the first SRS resource set based on the signaling.

In some examples of the method, apparatuses, and non-transitory computer-readable medium described herein, determining that the first slot may be available may include operations, features, means, or instructions for determining that the first slot may be available for the indirect assignment based on maintaining a guard period in the first slot, the guard period associated with the first SRS resource set and based on a set of ports associated with the first SRS.

Some examples of the method, apparatuses, and non-transitory computer-readable medium described herein may further include operations, features, means, or instructions for transmitting a second SRS in a second SRS resource set of the set of multiple SRS resource sets based on the signaling.

Some examples of the method, apparatuses, and non-transitory computer-readable medium described herein may further include operations, features, means, or instructions for maintaining a guard period between the first SRS resource set and the second SRS resource set based on the signaling, a first set of ports associated with the first SRS, and a second set of ports associated with the second SRS.

In some examples of the method, apparatuses, and non-transitory computer-readable medium described herein, the second SRS in the second SRS resource set may be transmitted in the first slot or a second slot of the one or more slots.

Some examples of the method, apparatuses, and non-transitory computer-readable medium described herein may further include operations, features, means, or instructions for determining a quantity of symbols in the first slot, the quantity of symbols including uplink symbols, flexible symbols, or both, where the second characteristics of the first slot include the quantity of symbols.

Some examples of the method, apparatuses, and non-transitory computer-readable medium described herein may further include operations, features, means, or instructions for suppressing transmitting, in the first slot, a first SRS in the first SRS resource set based on the quantity of symbols, a second SRS resource set of the set of multiple SRS resource sets, a guard period associated with the set of multiple SRS resource sets, a first set of ports associated with the first SRS, a second set of ports associated with a second SRS in the second SRS resource set, or any combination thereof.

Some examples of the method, apparatuses, and non-transitory computer-readable medium described herein may further include operations, features, means, or instructions for transmitting, in the first slot, a first SRS in the first SRS resource set based on the quantity of symbols, the first characteristics of the first SRS resource set, the second characteristics of the first slot, third characteristics of the signaling, or any combination thereof and suppressing transmitting a second SRS in a second SRS resource set of the set of multiple SRS resource sets based on the quantity of symbols, the first characteristics of the first SRS resource set, the second characteristics of the first slot, the third characteristics of the signaling, or any combination thereof.

In some examples of the method, apparatuses, and non-transitory computer-readable medium described herein, the third characteristics of the signaling include first control signaling associated with the first SRS resource set, second control signaling associated with the second SRS resource set, a first type of the first control signaling, a second type of the second control signaling, or any combination thereof.

In some examples of the method, apparatuses, and non-transitory computer-readable medium described herein, the first characteristics of the first SRS resource set include a first set of ports associated with the first SRS, an identifier associated with the first SRS resource set, a quantity of SRS resources in the first SRS resource set, a quantity of reference signal symbols in the first SRS resource set, a transmission power associated with the first SRS resource set, a reference signal codebook associated with the first SRS resource set, a frequency sounding configuration associated with the first SRS resource set, or any combination thereof.

A method for wireless communications at a base station is described. The method may include transmitting, to a UE, signaling indicating an indirect assignment of one or more slots for a set of multiple SRS resource sets, determining that a first slot of the one or more slots is available for the indirect assignment for at least a first SRS resource set of the set of multiple SRS resource sets based on first characteristics of the first SRS resource set and second characteristics of the first slot, and monitoring for signaling from the UE in at least a portion of the first slot based on determining that the first slot is indicated for the indirect assignment.

An apparatus for wireless communications at a base station is described. The apparatus may include a processor, memory coupled with the processor, and instructions stored in the memory. The instructions may be executable by the processor to cause the apparatus to transmit, to a UE, signaling indicating an indirect assignment of one or more slots for a set of multiple SRS resource sets, determine that a first slot of the one or more slots is available for the indirect assignment for at least a first SRS resource set of the set of multiple SRS resource sets based on first characteristics of the first SRS resource set and second characteristics of the first slot, and monitor for signaling from the UE in at least a portion of the first slot based on determining that the first slot is indicated for the indirect assignment.

Another apparatus for wireless communications at a base station is described. The apparatus may include means for transmitting, to a UE, signaling indicating an indirect assignment of one or more slots for a set of multiple SRS resource sets, means for determining that a first slot of the one or more slots is available for the indirect assignment for at least a first SRS resource set of the set of multiple SRS resource sets based on first characteristics of the first SRS resource set and second characteristics of the first slot, and means for monitoring for signaling from the UE in at least a portion of the first slot based on determining that the first slot is indicated for the indirect assignment.

A non-transitory computer-readable medium storing code for wireless communications at a base station is described. The code may include instructions executable by a processor to transmit, to a UE, signaling indicating an indirect assignment of one or more slots for a set of multiple SRS resource sets, determine that a first slot of the one or more slots is available for the indirect assignment for at least a first SRS resource set of the set of multiple SRS resource sets based on first characteristics of the first SRS resource set and second characteristics of the first slot, and monitor for signaling from the UE in at least a portion of the first slot based on determining that the first slot is indicated for the indirect assignment.

In some examples of the method, apparatuses, and non-transitory computer-readable medium described herein, monitoring for the signaling from the UE in the at least the portion of the first slot may include operations, features, means, or instructions for monitoring, in the first slot, for a first SRS in the first SRS resource set based on the signaling.

Some examples of the method, apparatuses, and non-transitory computer-readable medium described herein may further include operations, features, means, or instructions for suppressing monitoring for the signaling from the UE in a guard period in the first slot based on the signaling and a set of ports associated with the first SRS.

Some examples of the method, apparatuses, and non-transitory computer-readable medium described herein may further include operations, features, means, or instructions for monitoring for a second SRS in a second SRS resource set of the set of multiple SRS resource sets based on the signaling.

Some examples of the method, apparatuses, and non-transitory computer-readable medium described herein may further include operations, features, means, or instructions for suppressing monitoring for the signaling from the UE in a guard period between the first SRS resource set and the second SRS resource set based on the signaling, a first set of ports associated with the first SRS, and a second set of ports associated with the second SRS.

In some examples of the method, apparatuses, and non-transitory computer-readable medium described herein, monitoring for the second SRS may include operations, features, means, or instructions for monitoring for the second SRS in the first slot or a second slot of the one or more slots.

Some examples of the method, apparatuses, and non-transitory computer-readable medium described herein may further include operations, features, means, or instructions for determining a quantity of symbols in the first slot, the quantity of symbols including uplink symbols, flexible symbols, or both, where the second characteristics of the first slot include the quantity of symbols.

Some examples of the method, apparatuses, and non-transitory computer-readable medium described herein may further include operations, features, means, or instructions for suppressing monitoring, in the first slot, for a first SRS in the first SRS resource set based on the quantity of symbols, a second SRS resource set of the set of multiple SRS resource sets, a guard period associated with the set of multiple SRS resource sets, a first set of ports associated with the first SRS, a second set of ports associated with a second SRS in the second SRS resource set, or any combination thereof.

Some examples of the method, apparatuses, and non-transitory computer-readable medium described herein may further include operations, features, means, or instructions for monitoring, in the first slot, for a first SRS in the first SRS resource set based on the quantity of symbols, the first characteristics of the first SRS resource set, the second characteristics of the first slot, third characteristics of the signaling, or any combination thereof and suppressing monitoring for a second SRS in a second SRS resource set of the set of multiple SRS resource sets based on the signaling, the quantity of symbols, the first characteristics of the first SRS resource set, the second characteristics of the first slot, the third characteristics of the signaling, or any combination thereof.

In some examples of the method, apparatuses, and non-transitory computer-readable medium described herein, the third characteristics of the signaling include first control signaling associated with the first SRS resource set, second control signaling associated with the second SRS resource set, a first type of the first control signaling, a second type of the second control signaling, or any combination thereof.

In some examples of the method, apparatuses, and non-transitory computer-readable medium described herein, the first characteristics of the first SRS resource set include a first set of ports associated with the first SRS, an identifier associated with the first SRS resource set, a quantity of reference signal resources in the first SRS resource set, a quantity of reference signal symbols in the first SRS resource set, a transmission power associated with the first SRS resource set, a reference signal codebook associated with the first SRS resource set, a frequency sounding configuration associated with the first SRS resource set, or any combination thereof.

### BRIEF DESCRIPTION OF THE DRAWINGS

FIG. 1 illustrates an example of a wireless communications system that supports guard periods for sounding reference signal (SRS) resource sets in accordance with aspects of the present disclosure.

FIG. 2 illustrates an example of a wireless communications system that supports guard periods for SRS resource sets in accordance with aspects of the present disclosure.

FIGS. 3A and 3B illustrate examples of communication schedules that support guard periods for SRS resource sets in accordance with aspects of the present disclosure.

FIG. 4 illustrates an example of a process flow that supports guard periods for SRS resource sets in accordance with aspects of the present disclosure.

FIGS. 5 and 6 show block diagrams of devices that support guard periods for SRS resource sets in accordance with aspects of the present disclosure.

FIG. 7 shows a block diagram of a communications manager that supports guard periods for SRS resource sets in accordance with aspects of the present disclosure.

FIG. 8 shows a diagram of a system including a device that supports guard periods for SRS resource sets in accordance with aspects of the present disclosure.

FIGS. 9 and 10 show block diagrams of devices that support guard periods for SRS resource sets in accordance with aspects of the present disclosure.

FIG. 11 shows a block diagram of a communications manager that supports guard periods for SRS resource sets in accordance with aspects of the present disclosure.

FIG. 12 shows a diagram of a system including a device that supports guard periods for SRS resource sets in accordance with aspects of the present disclosure.

FIGS. 13 through 16 show flowcharts illustrating methods that support guard periods for SRS resource sets in accordance with aspects of the present disclosure.

### DETAILED DESCRIPTION

In some wireless communications systems, a base station may configure a user equipment (UE) to transmit sounding reference signals (SRSs) to the base station. The base station may receive the SRSs and use the received SRSs to perform channel estimation. In some cases, the base station may configure the UE to transmit SRSs using different antenna ports. In such cases, the UE may perform an antenna switching procedure to switch between the different antenna ports. The UE may include one or more guard periods between the SRSs to ensure that the UE has time to switch between the different antenna ports.

In some cases, the base station may configure the UE to transmit SRSs in an SRS resource set. An SRS resource set may include a set of resources (e.g., time resources, frequency resources, or both) in which the UE may transmit SRSs. In some cases, the base station may transmit, to the UE, an indirect assignment of one or more slots for transmitting SRSs in one or more SRS resource sets. That is, rather than directly assigning the one or more SRS resource sets to resources of the one or more slots, the base station may configure the UE to dynamically assign the one or more SRS resource sets to the resources of the one or more slots. For example, the UE may determine that a slot is available for an SRS resource set by comparing available resources of each slot (e.g., after an offset) with resources of the SRS resource set and may dynamically assign the SRS resource set to a slot having sufficient available resources (e.g., sufficient uplink symbols, sufficient frequency resources within the symbols that are not otherwise allocated). Accordingly, the UE may transmit SRSs in the SRS resource set assigned to the resources of the slot.

In some cases, the UE may determine that a slot is available for multiple SRS resource sets. In some cases, however, if the UE is configured to transmit SRSs in the multiple SRS resource sets using different antenna ports, the UE may be unable to perform an antenna switching procedure between the multiple SRS resource sets (e.g., if the multiple SRS resource sets are consecutive in the time domain). As a result, the UE may be unable to successfully transmit SRSs in the multiple SRS resource sets within the quantity of available uplink symbols or flexible symbols in the slot.

In accordance with various aspects of the present disclosure, a UE may selectively transmit SRSs in SRS resource sets in a slot, for example based on characteristics of the slot and characteristics of the SRS resource sets. In some examples, the UE may determine a quantity of guard periods to include between the multiple SRS resource sets based on the characteristics of the SRS resource sets. In some examples, the UE may selectively refrain from transmitting SRSs in one or more of the multiple SRS resource sets within the slot, for example based on a set of preconfigured rules. In some examples, the UE may apply the described techniques to SRS resource sets that are consecutive in the time domain and assigned to different slots.

Aspects of the present disclosure may be implemented to realize one or more of the following advantages. The described techniques may provide for improved SRS transmission at a UE. More specifically, the described techniques may enable a UE to transmit SRSs in SRS resource sets to a base station with relatively greater efficiency based on transmitting multiple SRS resource sets in a slot. For example, transmitting SRSs in multiple SRS resource sets in a slot may enable the UE to reduce a quantity of unused symbols in the slot, thereby improving throughput levels associated with the slot. Additionally, the described techniques may enable the UE to dynamically assign multiple SRS resource sets to one or more slots so as to increase the likelihood of the UE successfully transmitting the multiple SRS resource sets.

Aspects of the disclosure are initially described in the context of wireless communications systems, a communication schedule, and a process flow. Aspects of the disclosure are further illustrated by and described with reference to apparatus diagrams, system diagrams, and flowcharts that relate to guard periods for SRS resource sets.

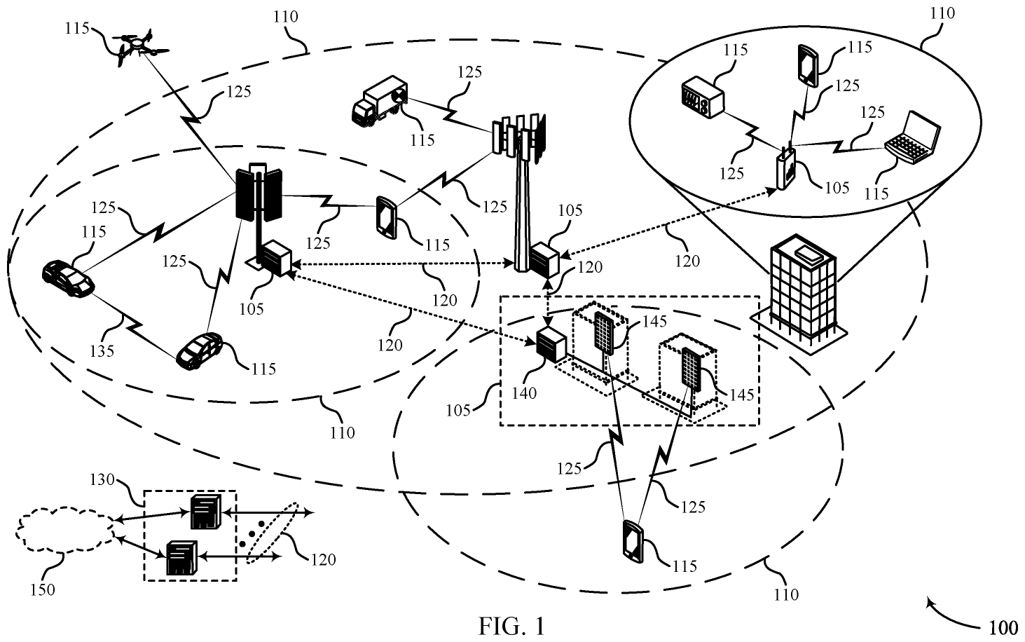

FIG. 1 illustrates an example of a wireless communications system 100 that supports guard periods for SRS resource sets in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In the wireless communications system 100, a UE 115 may transmit one or more SRSs in an SRS resource set (e.g., a set of frequency resources, time resources, or both). In some cases, the UE 115 may receive, from a base station 105, signaling that indicates an indirect assignment of a slot for transmitting SRSs in multiple SRS resource sets. That is, the base station 105 may configure the UE 115 to dynamically assign the multiple SRS resource sets to the slot. The UE 115 may determine whether the slot is available for an indirect assignment of a first SRS resource set of the multiple SRS resource sets based on a first set of characteristics associated with the first SRS resource set and a second set of characteristics associated with the slot. Additionally, or alternatively, the UE 115 may determine whether the slot is available for an indirect assignment of a second SRS resource set of the multiple SRS resource sets based on the first set of characteristics, the second set of characteristics, and a third set of characteristics associated with the second SRS resource set.

In some examples, the UE 115 may determine whether the slot is available for indirect assignments of the first SRS resource set and the second SRS resource set based on using the first set of characteristics and the third set of characteristics to determine a quantity of guard periods for the first SRS resource set and the second SRS resource set. In some other examples, the UE 115 may determine whether the slot is available for indirect assignments of the first SRS resource set and the second SRS resource set based on determining whether the first set of characteristics, the second set of characteristics, and the third set of characteristics satisfy a set of criteria. If, for example, the UE 115 determines that the slot is unavailable for indirect assignments of the first SRS resource set and the second SRS resource set, the UE 115 may selectively drop (e.g., refrain from transmitting in) either the first SRS resource set or the second SRS resource set according to a set of preconfigured rules. Alternatively, if the UE 115 determines that the slot is unavailable, the UE 115 may generate an error and refrain from transmitting in the first SRS resource set and the second SRS resource set. Determining whether the slot is available for indirect assignments of the first SRS resource set and the second SRS resource set may enable the UE 115 to transmit SRSs to the base station 105 with relatively higher efficiency and improved reliability, among other benefits.

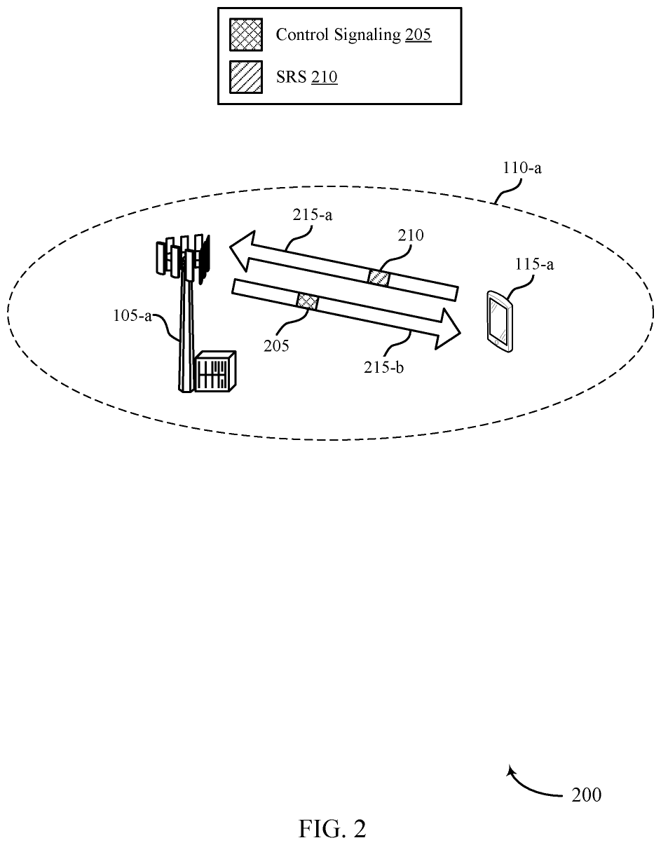

FIG. 2 illustrates an example of a wireless communications system 200 that supports guard periods for SRS resource sets in accordance with aspects of the present disclosure. The wireless communications system 200 may implement or be implemented by aspects of wireless communications system 100. For example, the wireless communications system 200 may include a base station 105-a and a UE 115-a, which may be examples of corresponding devices described with reference to FIG. 1. The base station 105-a may communicate with the UE 115-a using a communication link 215-a (e.g., an uplink channel) and a communication link 215-b (e.g., a downlink channel), which may be examples of a communication link 125 as described with reference to FIG. 1. The base station 105-a may communicate with the UE 115-a in a geographic coverage area 110-a, which may be an example of a geographic coverage area 110 as described with reference to FIG. 1. In the wireless communications system 200, the base station 105-a may transmit control signaling 205 to the UE 115-a using the communication link 215-b. Accordingly, the UE 115-a may transmit one or more SRSs 210 to the base station 105-a over the communication link 215-a based on the control signaling 205.

In some wireless communications systems, the base station 105-a may transmit control signaling 205 to the UE 115-a. The control signaling 205 may configure the UE 115-a to transmit an SRS 210 to the base station 105-a in an SRS resource set. In some cases, if the UE 115-a is configured to transmit the SRS 210 using different antenna ports, the UE 115-a may perform an antenna switching procedure to switch between the different antenna ports. To perform the antenna switching procedure, the UE 115-a may reconfigure an antenna panel of the UE 115-a, switch between antenna panels of the UE 115-a, switch between receive chains of the UE 115-a, or a combination thereof. In some cases, reconfiguring the antenna panel of the UE 115-a may include applying new analog weights to the antenna panel.

To ensure that the UE 115-a has time to perform the antenna switching procedure, the UE 115-a may be configured with a guard period between SRS resources in the SRS resource set. During the guard period, the UE 115-a may refrain from transmitting other signals. As such, if the UE 115-a is configured to transmit the SRS 210 in SRS resources in the same slot using different antenna ports, the guard period may enable the UE 115-a to perform an antenna switching procedure between the SRS resources. In some cases, a duration of the guard period may be based on capabilities of the UE 115-a, a subcarrier spacing of the UE 115-a, or both. In some cases, the guard period may be increased as the subcarrier spacing increases (e.g., and corresponding symbol period is reduced). For example, a subcarrier spacing up to and including 60 kHz may correspond to a guard period of 1 symbol, and a subcarrier spacing of 120 kHz may correspond to a guard period of 2 symbols. A guard period for subcarrier spacings above 120 kHz may have additional symbols (e.g., 3 symbols, 4 symbols).

In some cases, the UE 115-a may have different antenna configurations. For example, the UE 115-a may have a one-transmit two-receive (1T2R) antenna configuration, a one-transmit four-receive (1T4R) antenna configuration, a two-transmit four-receive (2T4R) antenna configuration, a one-transmit one-receive (1T1R) antenna configuration, a two-transmit two-receive (2T2R) antenna configuration, or a four-transmit four-receive (4T4R) antenna configuration, among other examples. For some antenna configurations (e.g., 1T2R, 1T4R, 2T4R), the UE may not expect the control signaling 205 to configure or trigger more than one SRS resource set with a higher-layer parameter (e.g., a usage parameter in RRC signaling) set to a value (e.g., “antennaSwitching”) within the same slot. For other antenna configurations (e.g., 1TIR, 2T2R, 4T4R), the UE 115-a may not expect the control signaling 205 to configure or trigger more than one SRS resource set with the higher-layer parameter set to the value (e.g., “antennaSwitching”) in the same symbol.

In some cases, the base station 105-a may configure the UE 115-a to transmit the SRS 210 in an aperiodic SRS resource set within a next available slot (e.g., a (t+1)-th available slot) with respect to a reference slot based on transmitting an indication of a timing parameter (e.g., t) to the UE 115-a via the control signaling 205. The control signaling 205 may include a downlink control information (DCI) message or RRC signaling. In some cases, the control signaling 205 (e.g., the RRC signaling) may configure a single value for the timing parameter. In other cases, the timing parameter may have more than one candidate value (e.g., including 0), which may be configured by the base station 105-a. In some cases, the UE 115-a may dynamically identify the next available slot for transmitting the SRS 210 in the aperiodic SRS resource set indicated by the control signaling 205. The next available slot may refer to a slot with uplink or flexible symbols for all time domain locations of SRS resources in the aperiodic SRS resource set. Additionally, the available slot may satisfy a threshold time duration between an SRS trigger (e.g., a triggering physical downlink control channel (PDCCH) included in the control signaling 205) and the SRS resources in the aperiodic SRS resource set. The base station 105-a may use the control signaling 205 (e.g., a DCI message) to indirectly indicate the available slot to the UE 115-a. In some cases, however, the control signaling 205 may indirectly trigger the UE 115-a to transmit SRSs 210 in multiple SRS resource sets during the available slot without indicating guard period settings for the multiple SRS resource sets.

In the wireless communications system 200, the UE 115-a may determine whether to transmit SRSs 210 in multiple SRS resource sets within the available slot (or two available slots that are consecutive in the time domain) based on a quantity of guard periods, a quantity of error cases, a quantity of predefined rules, or a combination thereof. In some examples, when determining if a slot is available for multiple SRS resource sets, the UE 115-a may include a guard period for each of the multiple SRS resource sets, even if the multiple SRS resource sets are configured with the same antenna ports. In such examples, the UE 115-a may identify available slots based on the guard period and all SRS resources in the multiple SRS resource sets. In some other examples, the UE 115-a may selectively include guard periods between SRS resource sets that are configured with different antenna ports and may identify available slots accordingly. In contrast, if the same antenna ports are used for the multiple SRS resource sets, the UE 115-a may identify available slots based on the SRS resources in the multiple SRS resource sets (e.g., without including any guard periods). If a quantity of unoccupied uplink or flexible symbols in a slot is less than a quantity of symbols associated with all SRS resources and corresponding guard periods in the multiple SRS resources, the UE 115-a may determine that the slot is unavailable (e.g., not valid) for the multiple SRS resource sets.

In some other examples, the UE 115-a may use one or more error cases to determine whether to transmit SRSs 210 in the multiple SRS resource sets. For example, when identifying available slots for the multiple SRS resource sets, the UE 115-a may count the quantity of uplink or flexible symbols in a slot and may use this quantity to determine whether the slot is available for the multiple SRS resource sets. Once the UE 115-a has determined that a slot has a sufficient quantity of available symbols for the multiple SRS resource sets, the UE 115-a may use one or more error cases to determine whether to transmit SRSs 210 in the multiple SRS resource sets. For example, the UE 115-a may determine whether the multiple SRS resource sets are associated with a higher layer parameter value (e.g., “antennaSwitching”) and whether the multiple SRS resource sets satisfy a set of criteria. If the multiple SRS resource sets are not associated with the higher layer parameter value or do not satisfy the set of criteria, the UE 115-a may transmit SRSs 210 in the multiple SRS resource sets. Otherwise, the UE 115-a may generate an error and may refrain from transmitting SRSs 210 in the multiple SRS resource sets. In some cases, the set of criteria may include whether the multiple SRS resource sets are indirectly assigned to the same slot, whether the SRS resource sets are consecutive in the time domain, whether the multiple SRS resource sets include intervening guard periods, whether the multiple SRS resource sets are configured with different antenna ports, or a combination thereof.

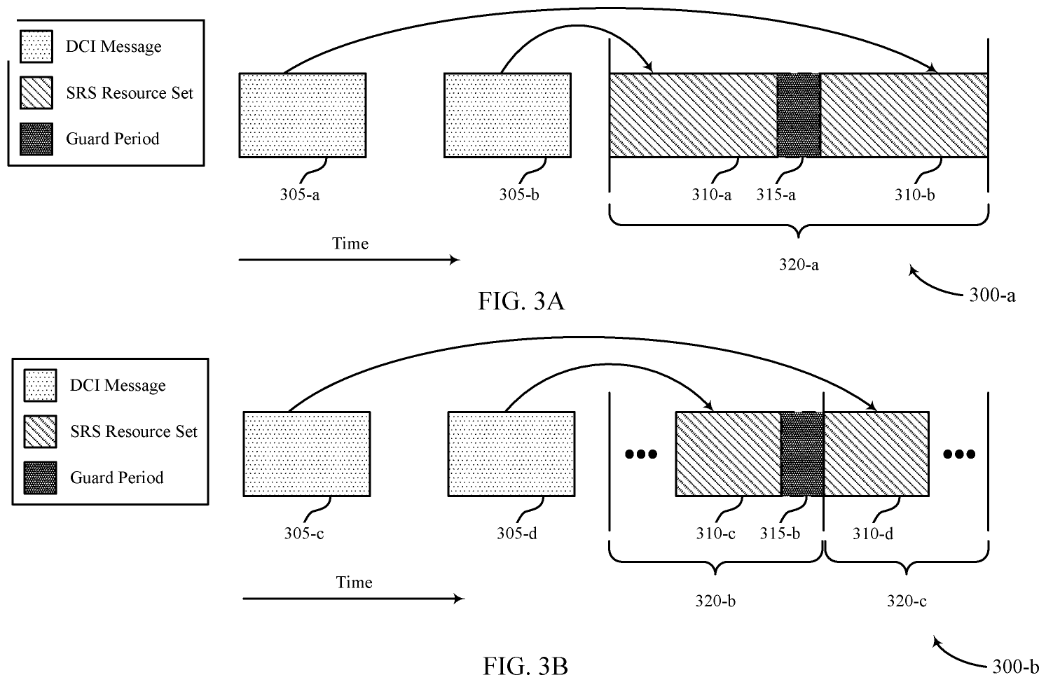

In some examples, if the multiple SRS resource sets are assigned to a single slot, the UE 115-a may use a set of preconfigured rules to determine whether to transmit in or drop (e.g., refrain from transmitting in) the multiple SRS resource sets, as described with reference to FIG. 3. Additionally, or alternatively, the UE 115-a may use the described techniques to determine whether to transmit SRSs 210 in SRS resource sets that are assigned to adjacent slots. For example, if a first SRS resource set is indirectly assigned to a first slot and a second SRS resource set is indirectly assigned to a second slot that is adjacent to the first slot such that a last symbol of the first SRS resource set is adjacent to a first symbol of the second SRS resource set, the UE 115-a may employ the described techniques to determine whether to transmit SRSs 210 in the first SRS resource set, the second SRS resource set, or both. The described techniques may enable the UE 115-a to transmit SRSs 210 with greater efficiency and improved reliability, among other benefits.

FIGS. 3A and 3B illustrate examples of communication schedules 300 that support guard periods for SRS resource sets in accordance with aspects of the present disclosure. The communication schedules 300 may implement or be implemented by aspects of the wireless communications system 100 or the wireless communications system 200. For example, the communication schedules 300 may be implemented by a UE or a base station, which may be examples of corresponding devices described with reference to FIGS. 1 and 2. In accordance with the communication schedules 300, the base station may indirectly assign one or more slots 320 for transmitting SRSs in SRS resource sets 310 to the UE via DCI messages 305. The communication schedules 300 may enable the UE to transmit SRSs in the SRS resource sets 310 with greater efficiency and improved reliability based on enabling the UE to dynamically allocate the SRS resource sets 310 to the one or more slots 320.

In the communication schedule 300-a illustrated in FIG. 3A, the base station may transmit a DCI message 305-a to the UE. The DCI message 305-a may indicate, to the UE, an indirect assignment of a slot 320 for transmitting SRSs in an SRS resource set 310-a. Likewise, the base station may transmit a DCI message 305-b to the UE that indicates an indirect assignment of an SRS resource set 310-b to a slot 320. The UE may identify slots 320 that are available for transmitting SRSs in the SRS resource sets 310 based on comparing a quantity of available uplink or flexible symbols in the slots 320 to a quantity of symbols in the SRS resource sets 310-a and 310-b. If the quantity of available uplink or flexible symbols in the slots 320 is greater than or equal to the quantity of symbols in the SRS resource sets 310-a and 310-b, the UE may dynamically assign the SRS resource sets 310-a and 310-b to the slots 320. Additionally, or alternatively, the UE may dynamically assign the SRS resource sets 310-a and 310-b based on whether the SRS resource sets 310-a and 310-b are configured with a guard period 315-a.

In some examples, the UE may use a rule (e.g., a predefined or predetermined rule at the UE) to select (e.g., transmit SRSs in) one or both of the SRS resource sets 310-a and 310-b. For example, if the SRS resource sets 310-a and 310-b are both assigned to a same slot 320-a and the UE is configured to transmit SRSs in both of the SRS resource sets 310-a and 310-b using the same antenna ports, the UE may select both of the SRS resource sets 310-a and 310-b. Alternatively, if the SRS resource sets 310-a and 310-b are assigned to the slot 320-a and the UE is configured to transmit SRSs in the SRS resource sets 310-a and 310-b using different antenna ports, the UE may use the rule to select one of the SRS resource set 310-a or the SRS resource set 310-b and drop (e.g., refrain from transmitting in) the other SRS resource set 310.

In some examples, the rule may be based on which SRS resource set 310 was triggered first. For example, the UE may select the SRS resource set 310-b based on the rule because the SRS resource set 310-b was triggered by the DCI message 305-a, which the UE received before the DCI message 305-b. Alternatively, if the rule is based on which SRS resource set 310 was triggered more recently, the UE may select the SRS resource set 310-a and may drop the SRS resource set 310-b.

In some examples, the rule may be based on respective parameters associated with each SRS resource set 310. For example, the UE may select either the SRS resource set 310-a or the SRS resource set 310-b based on which SRS resource set 310 has a higher or lower SRS resource set identifier, a higher or lower quantity of associated SRS resources, a higher or lower quantity of associated SRS symbols, a higher or lower transmit power, or a combination thereof. Additionally, or alternatively, the UE may select the SRS resource set 310 with the greater quantity of SRS resources overlapping with codebook SRS resources of the UE. Additionally, or alternatively, the UE may select an SRS resource set 310 based on whether the SRS resource sets 310-a and 310-b are configured for full frequency sounding or partial frequency sounding.

In some examples, the UE may select an SRS resource set 310 based on a type of the DCI message 305 corresponding to (e.g., triggering) the selected SRS resource set 310. For example, the DCI message 305 may be a non-scheduling (e.g., a dummy) DCI message 305 or a scheduling DCI message 305. Additionally, or alternatively, the DCI message may be a UE-specific DCI message 305 or a group-common DCI message 305 (e.g., a DCI format 2_3).

In the communication schedule 300-b illustrated in FIG. 3B, the UE may dynamically assign SRS resource sets 310-c and 310-d to different slots. For example, the UE may assign the SRS resource set 310-c to a slot 320-b and may assign the SRS resource set 310-d to a slot 320-c, where the slot 320-c may be adjacent to the slot 320-b. Although the SRS resource sets 310-c and 310-d are assigned to different slots, the SRS resource sets 310-c and 310-d may be consecutive in the time-domain. In some examples, the UE may dynamically assign the SRS resource sets 310-c and 310-d to the slots 320-b and 320-c, respectively, based on whether the SRS resource sets 310-c and 310-d are configured with a guard period 315-b. Additionally, or alternatively, the UE may use the techniques described herein to determine whether to select one or both of the SRS resource sets 310-c and 310-d for transmission. For example, if the SRS resource sets 310-c and 310-d are configured with the same antenna ports, the UE may select both of the SRS resource sets 310-c and 310-d. Alternatively, if the SRS resource sets 310-c and 310-d are configured with different antenna ports, the UE may select the SRS resource set 310 (e.g., the SRS resource set 310-c) that is assigned to later symbols in the respective slot.

Implementing the communication schedules 300 in accordance with techniques described herein may enable the UE to transmit SRSs to the base station in the SRS resource sets 310 with greater efficiency and improved reliability, among other benefits. For example, the described techniques may enable the UE to dynamically assign the SRS resource sets 310 to the slots 320, which may improve the likelihood of the UE successfully transmitting SRSs in the SRS resource sets 310.

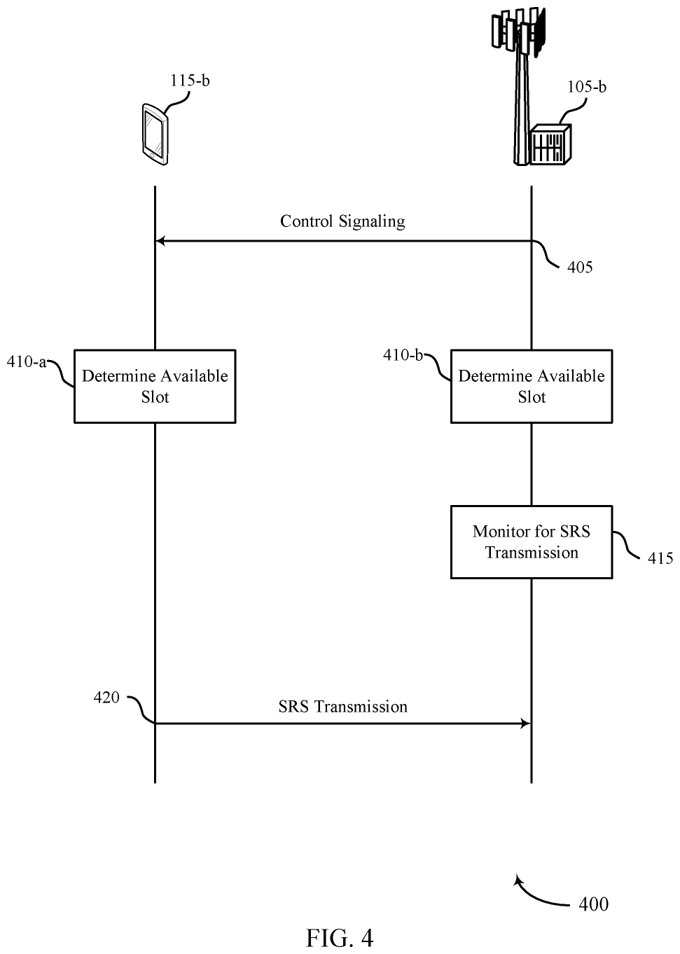

FIG. 4 illustrates an example of a process flow 400 that supports guard periods for SRS resource sets in accordance with aspects of the present disclosure. The process flow 400 may implement or be implemented by aspects of the wireless communications system 100 or the wireless communications system 200. For example, the process flow 400 may illustrate operations between a base station 105-b and a UE 115-b, which may be examples of corresponding devices described with reference to FIGS. 1 and 2. In the following description of the process flow 400, operations between the base station 105-b and the UE 115-b may be performed in a different order or at a different time than as shown. Some operations may also be omitted from the process flow 400, and other operations may be added to the process flow 400. In the process flow 400, the base station 105-b may configure the UE 115-b to transmit SRSs in one or more SRS resource sets during one or more slots.

At 405, the UE 115-b may receive control signaling from the base station 105-b. The control signaling may indicate an indirect assignment of one or more slots for transmitting SRSs in multiple SRS resource sets. In some examples, the control signaling may include a DCI message or RRC signaling.

At 410-a, the UE 115-b may determine whether a first slot is available for transmitting SRSs in a first SRS resource set based on first characteristics of the first SRS resource set and second characteristics of the first slot. At 410-b, the base station 105-b may also determine whether the first slot is available based on the first characteristics and the second characteristics. In some examples, the first characteristics of the first SRS resource set may include a first set of ports, an identifier, a quantity of SRS resources, a quantity of SRS symbols, a transmission power, an SRS codebook, a frequency sounding configuration, or a combination thereof. The second characteristics may include a quantity of uplink symbols, flexible symbols, or both, in the first slot.

In some examples, the UE 115-b may determine whether the first slot is available based on maintaining a guard period in the first slot. The guard period may be associated with the first SRS resource set or a first SRS to be transmitted in the first SRS resource set. In some examples, the UE 115-b may maintain the guard period between the first SRS resource set and a second SRS resource set based on the control signaling, a first set of ports associated with the first SRS, a second set of ports associated with a second SRS to be transmitted in the second SRS resource set, or a combination thereof.

At 415, the base station 105-b may monitor for signaling (e.g., SRS transmissions) from the UE 115-b during at least a portion of the first slot based on determining that the first slot is available for the indirect assignment. For example, the base station 105-b may monitor for the first SRS in the first SRS resource set during the first slot based on the first set of characteristics, the second set of characteristics, a third set of characteristics associated with the control signaling, or a combination thereof. The third set of characteristics may include first control signaling associated with the first SRS resource set, second control signaling associated with the second SRS resource set, a first type of the first control signaling, a second type of the second control signaling, or a combination thereof. In some examples, the base station 105-b may monitor for the second SRS in the second SRS resource set based on the first set of characteristics, the second set of characteristics, the third set of characteristics, or a combination thereof. The base station 105-b may monitor for the second SRS in the first slot or a second slot. In some examples, the base station 105-b may refrain from monitoring for signaling from the UE 115-b during the guard period based on the control signaling, the first set of ports, and the second set of ports.

In some examples, the base station 105-b may refrain from monitoring for the first SRS in the first SRS resource set during the first slot based on the second characteristics, the second SRS resource set, the guard period, the first set of ports, the second set of ports, or a combination thereof. In some other examples, the base station 105-b may monitor for the first SRS in the first SRS resource set during the first slot and may refrain from monitoring for the second SRS in the second SRS resource set based on the control signaling, the first characteristics, the second characteristics, the third characteristics, or a combination thereof.

At 420, the UE 115-b may communicate with the base station 105-b in the first slot based on determining that the first slot is available for the indirect assignment. For example, the UE 115-b may transmit, in the first slot, the first SRS in the first SRS resource set based on the control signaling. Additionally, or alternatively, the UE 115-b may transmit the second SRS in the second SRS resource set based on the control signaling. In some examples, the UE 115-b may transmit the second SRS in the first slot or the second slot.

In some examples, the UE 115-b may suppress transmission of the first SRS in the first SRS resource set during the first slot based on the second characteristics, the second SRS resource set, the guard period, the first set of ports, the second set of ports, or a combination thereof. In other examples, the UE 115-b may transmit the first SRS in the first SRS resource set during the first slot and may suppress transmission of the second SRS in the second SRS resource set during the first slot based on the first characteristics, the second characteristics, the third characteristics, or a combination thereof.

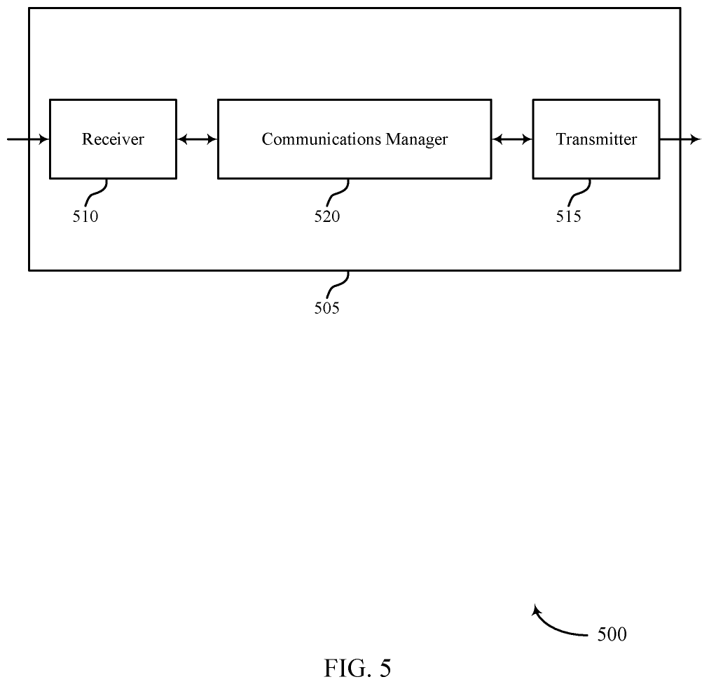

FIG. 5 shows a block diagram 500 of a device 505 that supports guard periods for SRS resource sets in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to guard periods for SRS resource sets). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to guard periods for SRS resource sets). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of guard periods for SRS resource sets as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for receiving, from a base station, signaling indicating an indirect assignment of one or more slots for a set of multiple SRS resource sets. The communications manager 520 may receive the signaling based on identifying time-frequency resources over which the signaling is transmitted, demodulating the signaling over the time-frequency resources, and decoding the demodulated signaling to obtain bits that indicate the indirect assignment.

The communications manager 520 may be configured as or otherwise support a means for determining that a first slot of the one or more slots is available for the indirect assignment for at least a first SRS resource set of the set of multiple SRS resource sets based on first characteristics of the first SRS resource set and second characteristics of the first slot. The communications manager 520 may be configured as or otherwise support a means for communicating with the base station in the first slot based on determining that the first slot is indicated for the indirect assignment.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for more efficient utilization of communication resources based on dynamically assigning one or more SRS resource sets to one or more time slots and selectively transmitting SRSs in the one or more dynamically assigned SRS resource sets.

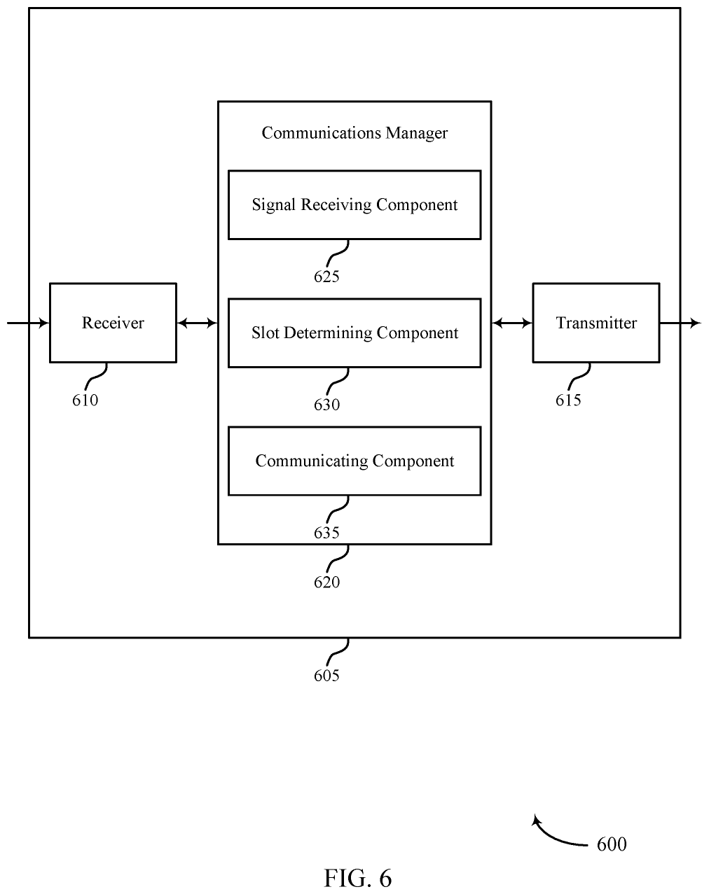

FIG. 6 shows a block diagram 600 of a device 605 that supports guard periods for SRS resource sets in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to guard periods for SRS resource sets). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to guard periods for SRS resource sets). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of guard periods for SRS resource sets as described herein. For example, the communications manager 620 may include a signal receiving component 625, a slot determining component 630, a communicating component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The signal receiving component 625 may be configured as or otherwise support a means for receiving, from a base station, signaling indicating an indirect assignment of one or more slots for a set of multiple SRS resource sets. The communications manager 620 may receive the signaling based on identifying time-frequency resources over which the signaling is transmitted, demodulating the signaling over the time-frequency resources, and decoding the demodulated signaling to obtain bits that indicate the indirect assignment.

The slot determining component 630 may be configured as or otherwise support a means for determining that a first slot of the one or more slots is available for the indirect assignment for at least a first SRS resource set of the set of multiple SRS resource sets based on first characteristics of the first SRS resource set and second characteristics of the first slot. The communicating component 635 may be configured as or otherwise support a means for communicating with the base station in the first slot based on determining that the first slot is indicated for the indirect assignment.

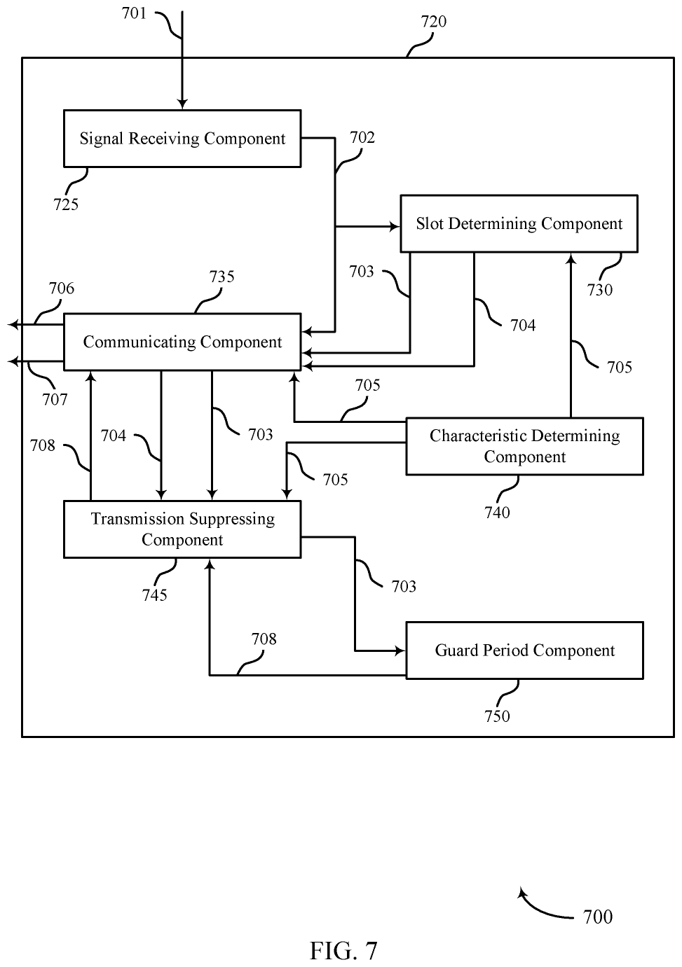

FIG. 7 shows a block diagram 700 of a communications manager 720 that supports guard periods for SRS resource sets in accordance with aspects of the present disclosure. The communications manager 720 may be an example of aspects of a communications manager 520, a communications manager 620, or both, as described herein. The communications manager 720, or various components thereof, may be an example of means for performing various aspects of guard periods for SRS resource sets as described herein. For example, the communications manager 720 may include a signal receiving component 725, a slot determining component 730, a communicating component 735, a characteristic determining component 740, a transmission suppressing component 745, a guard period component 750, or any combination thereof. Each of these components may communicate, directly or indirectly, with one another (e.g., via one or more buses).

The communications manager 720 may support wireless communications at a UE in accordance with examples as disclosed herein. The signal receiving component 725 may be configured as or otherwise support a means for receiving, from a base station, signaling 701 indicating an indirect assignment 702 of one or more slots for a set of multiple SRS resource sets. The communications manager 520 may receive the signaling 701 based on identifying time-frequency resources over which the signaling 701 is transmitted, demodulating the signaling 701 over the time-frequency resources, and decoding the demodulated signaling 701 to obtain bits that indicate the indirect assignment 702.

The slot determining component 730 may be configured as or otherwise support a means for determining that a first slot of the one or more slots is available for the indirect assignment 702 for at least a first SRS resource set 703 of the set of multiple SRS resource sets based on first characteristics 704 of the first SRS resource set and second characteristics 705 of the first slot. The communicating component 735 may be configured as or otherwise support a means for communicating with the base station in the first slot based on determining that the first slot is indicated for the indirect assignment 702.

In some examples, to support communicating with the base station in the first slot, the communicating component 735 may be configured as or otherwise support a means for transmitting, in the first slot, a first SRS 706 in the first SRS resource set 703 based on the signaling 701.

In some examples, to support determining that the first slot is available, the slot determining component 730 may be configured as or otherwise support a means for determining that the first slot is available for the indirect assignment 702 based on maintaining a guard period in the first slot, the guard period associated with the first SRS resource set 703 and based on a set of ports associated with the first SRS 706.

In some examples, the communicating component 735 may be configured as or otherwise support a means for transmitting a second SRS 707 in a second SRS resource set 708 of the set of multiple SRS resource sets based on the signaling 701.

In some examples, the guard period component 750 may be configured as or otherwise support a means for maintaining a guard period between the first SRS resource set 703 and the second SRS resource set 708 based on the signaling 701, a first set of ports associated with the first SRS 706, and a second set of ports associated with the second SRS 707.

In some examples, the second SRS 707 in the second SRS resource set 708 is transmitted in the first slot or a second slot of the one or more slots.

In some examples, the characteristic determining component 740 may be configured as or otherwise support a means for determining a quantity of symbols in the first slot, the quantity of symbols including uplink symbols, flexible symbols, or both, where the second characteristics 705 of the first slot include the quantity of symbols.

In some examples, the transmission suppressing component 745 may be configured as or otherwise support a means for suppressing transmitting, in the first slot, a first SRS 706 in the first SRS resource set 703 based on the quantity of symbols, a second SRS resource set of the set of multiple SRS resource sets, a guard period associated with the set of multiple SRS resource sets, a first set of ports associated with the first SRS 706, a second set of ports associated with a second SRS 707 in the second SRS resource set 708, or any combination thereof.

In some examples, the communicating component 735 may be configured as or otherwise support a means for transmitting, in the first slot, a first SRS 706 in the first SRS resource set 703 based on the quantity of symbols, the first characteristics 704 of the first SRS resource set 703, the second characteristics 705 of the first slot, third characteristics of the signaling 701, or any combination thereof. In some examples, the transmission suppressing component 745 may be configured as or otherwise support a means for suppressing transmitting a second SRS 707 in a second SRS resource set 708 of the set of multiple SRS resource sets based on the quantity of symbols, the first characteristics 704 of the first SRS resource set, the second characteristics 705 of the first slot, the third characteristics of the signaling, or any combination thereof.

In some examples, the third characteristics of the signaling 701 include first control signaling associated with the first SRS resource set 703, second control signaling associated with the second SRS resource set 708, a first type of the first control signaling, a second type of the second control signaling, or any combination thereof.

In some examples, the first characteristics 704 of the first SRS resource set 703 include a first set of ports associated with the first SRS 706, an identifier associated with the first SRS resource set 703, a quantity of SRS resources in the first SRS resource set 703, a quantity of reference signal symbols in the first SRS resource set 703, a transmission power associated with the first SRS resource set 703, a reference signal codebook associated with the first SRS resource set 703, a frequency sounding configuration associated with the first SRS resource set 703, or any combination thereof.

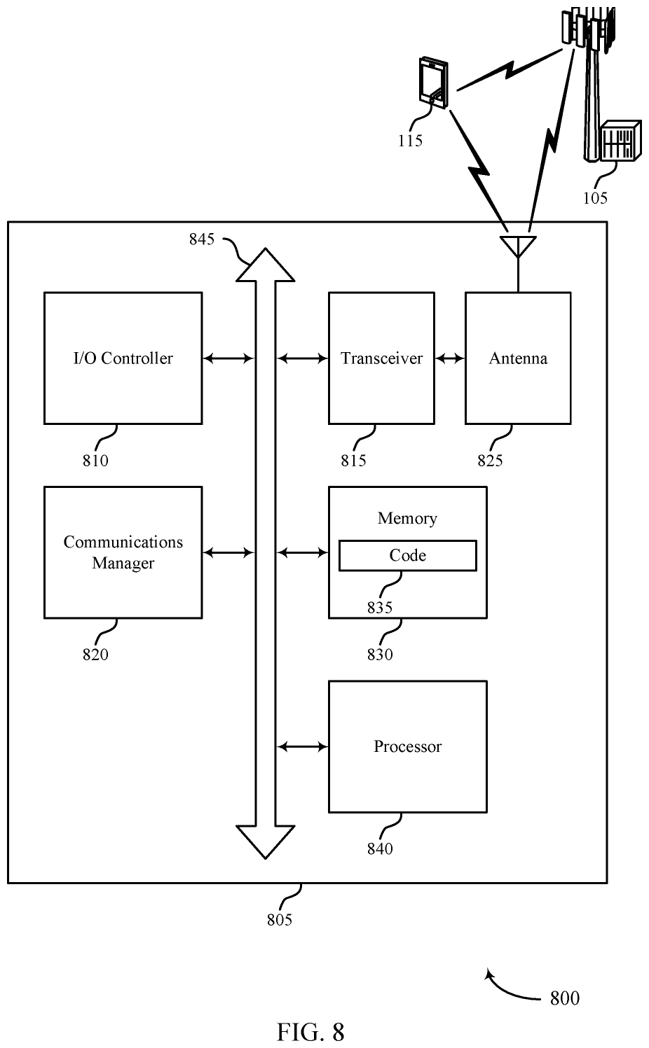

FIG. 8 shows a diagram of a system 800 including a device 805 that supports guard periods for SRS resource sets in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting guard periods for SRS resource sets). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving, from a base station, signaling indicating an indirect assignment of one or more slots for a set of multiple SRS resource sets. The communications manager 820 may receive the signaling based on identifying time-frequency resources over which the signaling is transmitted, demodulating the signaling over the time-frequency resources, and decoding the demodulated signaling to obtain bits that indicate the indirect assignment.

The communications manager 820 may be configured as or otherwise support a means for determining that a first slot of the one or more slots is available for the indirect assignment for at least a first SRS resource set of the set of multiple SRS resource sets based on first characteristics of the first SRS resource set and second characteristics of the first slot. The communications manager 820 may be configured as or otherwise support a means for communicating with the base station in the first slot based on determining that the first slot is indicated for the indirect assignment.

By including or configuring the communications manager 820 in accordance with examples as described herein, the device 805 may support techniques for improved communication reliability based on dynamically assigning one or more SRS resource sets to one or more slots and selectively transmitting SRSs in the one or more dynamically assigned SRS resource sets.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of guard periods for SRS resource sets as described herein, or the processor 840 and the memory 830 may be otherwise configured to perform or support such operations.

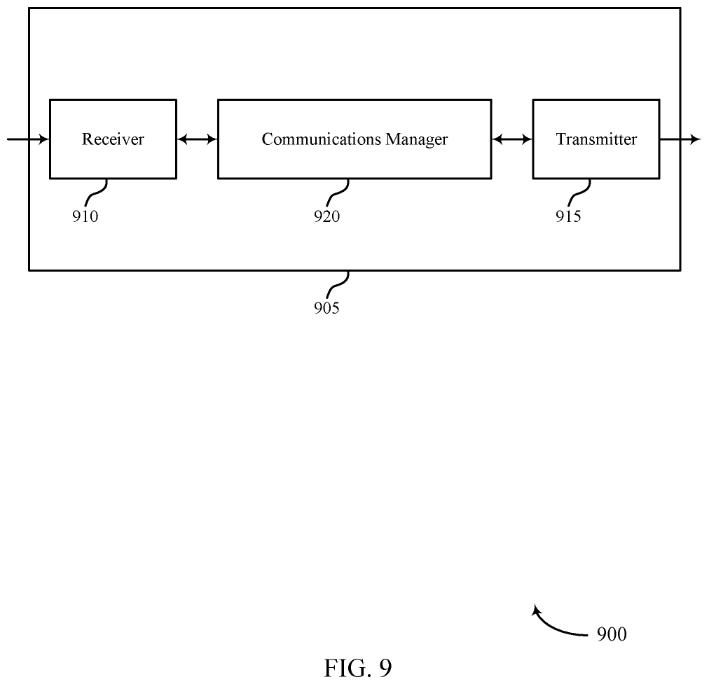

FIG. 9 shows a block diagram 900 of a device 905 that supports guard periods for SRS resource sets in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to guard periods for SRS resource sets). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to guard periods for SRS resource sets). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of guard periods for SRS resource sets as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a UE, signaling indicating an indirect assignment of one or more slots for a set of multiple SRS resource sets. The communications manager 920 may be configured as or otherwise support a means for determining that a first slot of the one or more slots is available for the indirect assignment for at least a first SRS resource set of the set of multiple SRS resource sets based on first characteristics of the first SRS resource set and second characteristics of the first slot. The communications manager 920 may be configured as or otherwise support a means for monitoring for signaling from the UE in at least a portion of the first slot based on determining that the first slot is indicated for the indirect assignment.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for more efficient utilization of communication resources based on indirectly assigning one or more SRS resource sets to one or more slots and selectively monitoring for SRS transmissions during the one or more slots.

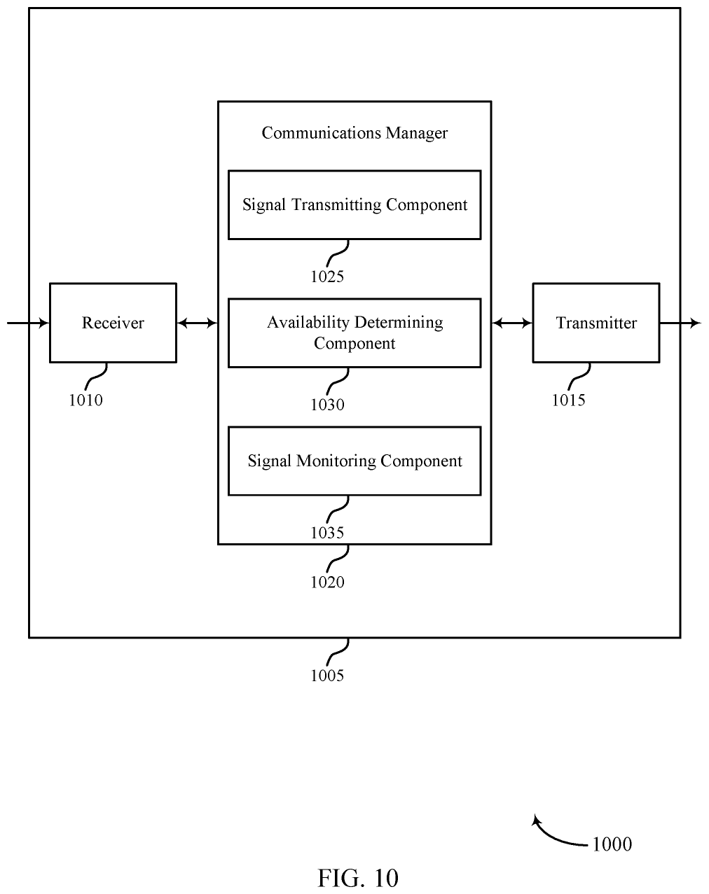

FIG. 10 shows a block diagram 1000 of a device 1005 that supports guard periods for SRS resource sets in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to guard periods for SRS resource sets). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to guard periods for SRS resource sets). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of guard periods for SRS resource sets as described herein. For example, the communications manager 1020 may include a signal transmitting component 1025, an availability determining component 1030, a signal monitoring component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The signal transmitting component 1025 may be configured as or otherwise support a means for transmitting, to a UE, signaling indicating an indirect assignment of one or more slots for a set of multiple SRS resource sets. The availability determining component 1030 may be configured as or otherwise support a means for determining that a first slot of the one or more slots is available for the indirect assignment for at least a first SRS resource set of the set of multiple SRS resource sets based on first characteristics of the first SRS resource set and second characteristics of the first slot. The signal monitoring component 1035 may be configured as or otherwise support a means for monitoring for signaling from the UE in at least a portion of the first slot based on determining that the first slot is indicated for the indirect assignment.

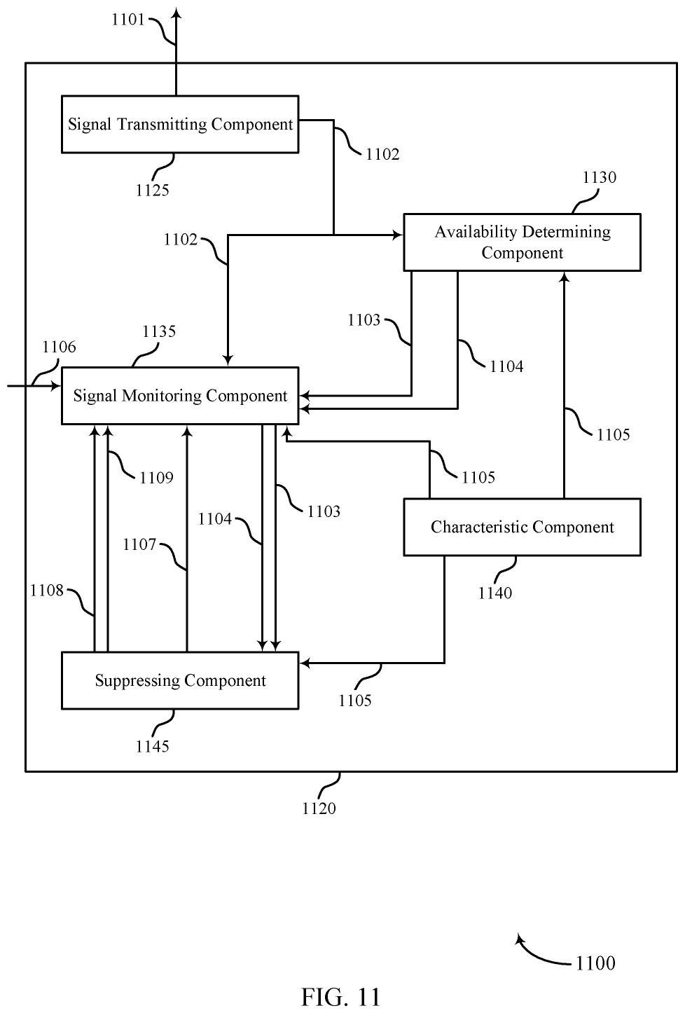

FIG. 11 shows a block diagram 1100 of a communications manager 1120 that supports guard periods for SRS resource sets in accordance with aspects of the present disclosure. The communications manager 1120 may be an example of aspects of a communications manager 920, a communications manager 1020, or both, as described herein. The communications manager 1120, or various components thereof, may be an example of means for performing various aspects of guard periods for SRS resource sets as described herein. For example, the communications manager 1120 may include a signal transmitting component 1125, an availability determining component 1130, a signal monitoring component 1135, a characteristic component 1140, a suppressing component 1145, or any combination thereof. Each of these components may communicate, directly or indirectly, with one another (e.g., via one or more buses).

The communications manager 1120 may support wireless communications at a base station in accordance with examples as disclosed herein. The signal transmitting component 1125 may be configured as or otherwise support a means for transmitting, to a UE, signaling 1101 indicating an indirect assignment 1102 of one or more slots for a set of multiple SRS resource sets. The availability determining component 1130 may be configured as or otherwise support a means for determining that a first slot of the one or more slots is available for the indirect assignment 1102 for at least a first SRS resource set 1103 of the set of multiple SRS resource sets based on first characteristics 1104 of the first SRS resource set 1103 and second characteristics 1105 of the first slot. The signal monitoring component 1135 may be configured as or otherwise support a means for monitoring for signaling 1106 from the UE in at least a portion of the first slot based on determining that the first slot is indicated for the indirect assignment 1102.

In some examples, to support monitoring for the signaling 1106 from the UE in the at least the portion of the first slot, the signal monitoring component 1135 may be configured as or otherwise support a means for monitoring, in the first slot, for a first SRS 1107 in the first SRS resource set 1103 based on the signaling 1101.

In some examples, the suppressing component 1145 may be configured as or otherwise support a means for suppressing monitoring for the signaling 1106 from the UE in a guard period in the first slot based on the signaling 1101 and a set of ports associated with the first SRS 1107.

In some examples, the signal monitoring component 1135 may be configured as or otherwise support a means for monitoring for a second SRS 1108 in a second SRS resource set 1109 of the set of multiple SRS resource sets based on the signaling 1101.

In some examples, the suppressing component 1145 may be configured as or otherwise support a means for suppressing monitoring for the signaling 1106 from the UE in a guard period between the first SRS resource set 1103 and the second SRS resource set 1109 based on the signaling, a first set of ports associated with the first SRS 1107, and a second set of ports associated with the second SRS 1108.

In some examples, to support monitoring for the second SRS, the signal monitoring component 1135 may be configured as or otherwise support a means for monitoring for the second SRS 1108 in the first slot or a second slot of the one or more slots.

In some examples, the characteristic component 1140 may be configured as or otherwise support a means for determining a quantity of symbols in the first slot, the quantity of symbols including uplink symbols, flexible symbols, or both, where the second characteristics 1105 of the first slot include the quantity of symbols.

In some examples, the suppressing component 1145 may be configured as or otherwise support a means for suppressing monitoring, in the first slot, for a first SRS 1107 in the first SRS resource set 1103 based on the quantity of symbols, a second SRS resource set 1109 of the set of multiple SRS resource sets, a guard period associated with the set of multiple SRS resource sets, a first set of ports associated with the first SRS 1107, a second set of ports associated with a second SRS 1108 in the second SRS resource set 1109, or any combination thereof.

In some examples, the signal monitoring component 1135 may be configured as or otherwise support a means for monitoring, in the first slot, for a first SRS 1107 in the first SRS resource set 1103 based on the quantity of symbols, the first characteristics 1104 of the first SRS resource set, the second characteristics 1105 of the first slot, third characteristics of the signaling, or any combination thereof. In some examples, the suppressing component 1145 may be configured as or otherwise support a means for suppressing monitoring for a second SRS 1108 in a second SRS resource set 1109 of the set of multiple SRS resource sets based on the signaling 1101, the quantity of symbols, the first characteristics 1104 of the first SRS resource set, the second characteristics 1105 of the first slot, the third characteristics of the signaling, or any combination thereof.

In some examples, the third characteristics of the signaling include first control signaling associated with the first SRS resource set 1103, second control signaling associated with the second SRS resource set 1109, a first type of the first control signaling, a second type of the second control signaling, or any combination thereof.

In some examples, the first characteristics 1104 of the first SRS resource set 1103 include a first set of ports associated with the first SRS 1107, an identifier associated with the first SRS resource set 1103, a quantity of reference signal resources in the first SRS resource set 1103, a quantity of reference signal symbols in the first SRS resource set 1103, a transmission power associated with the first SRS resource set 1103, a reference signal codebook associated with the first SRS resource set 1103, a frequency sounding configuration associated with the first SRS resource set 1103, or any combination thereof.

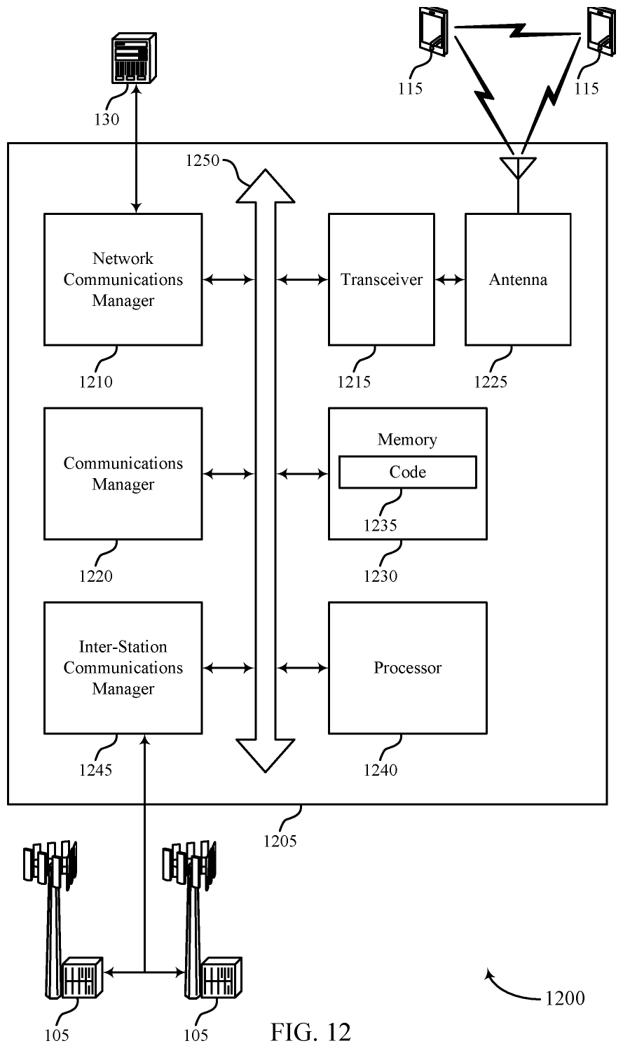

FIG. 12 shows a diagram of a system 1200 including a device 1205 that supports guard periods for SRS resource sets in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting guard periods for SRS resource sets). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a UE, signaling indicating an indirect assignment of one or more slots for a set of multiple SRS resource sets. The communications manager 1220 may be configured as or otherwise support a means for determining that a first slot of the one or more slots is available for the indirect assignment for at least a first SRS resource set of the set of multiple SRS resource sets based on first characteristics of the first SRS resource set and second characteristics of the first slot. The communications manager 1220 may be configured as or otherwise support a means for monitoring for signaling from the UE in at least a portion of the first slot based on determining that the first slot is indicated for the indirect assignment.

By including or configuring the communications manager 1220 in accordance with examples as described herein, the device 1205 may support techniques for improved communication reliability based on indirectly assigning one or more SRS resource sets to one or more slots and selectively monitoring for SRS transmissions during the one or more slots.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of guard periods for SRS resource sets as described herein, or the processor 1240 and the memory 1230 may be otherwise configured to perform or support such operations.

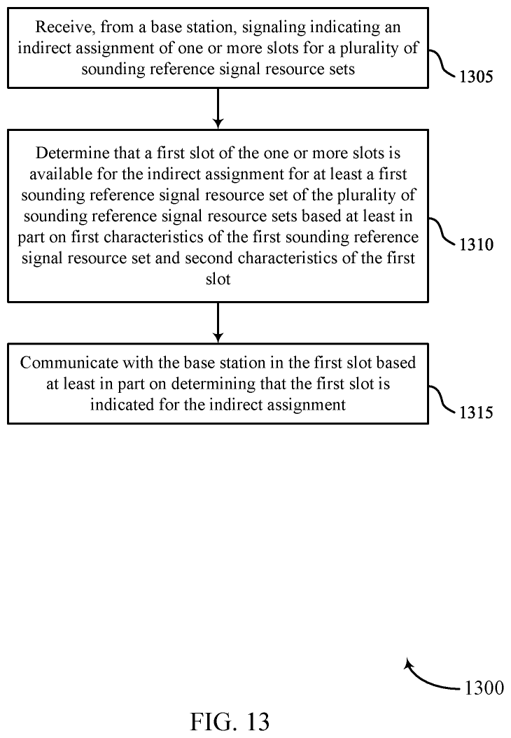

FIG. 13 shows a flowchart illustrating a method 1300 that supports guard periods for SRS resource sets in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a base station, signaling indicating an indirect assignment of one or more slots for a set of multiple SRS resource sets. In some examples, receiving the signaling may be based on identifying time-frequency resources over which the signaling is transmitted, demodulating the signaling over the time-frequency resources, and decoding the demodulated signaling to obtain bits that indicate the indirect assignment. The operations of 1305 may be performed in accordance with examples as disclosed herein. In some examples, aspects of the operations of 1305 may be performed by a signal receiving component 725 as described with reference to FIG. 7.

At 1310, the method may include determining that a first slot of the one or more slots is available for the indirect assignment for at least a first SRS resource set of the set of multiple SRS resource sets based on first characteristics of the first SRS resource set and second characteristics of the first slot. The operations of 1310 may be performed in accordance with examples as disclosed herein. In some examples, aspects of the operations of 1310 may be performed by a slot determining component 730 as described with reference to FIG. 7.

At 1315, the method may include communicating with the base station in the first slot based on determining that the first slot is indicated for the indirect assignment. The operations of 1315 may be performed in accordance with examples as disclosed herein. In some examples, aspects of the operations of 1315 may be performed by a communicating component 735 as described with reference to FIG. 7.

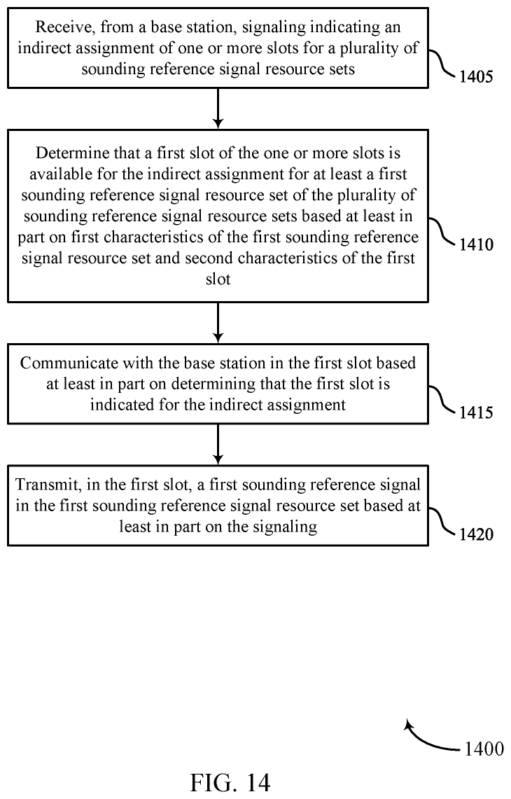

FIG. 14 shows a flowchart illustrating a method 1400 that supports guard periods for SRS resource sets in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a base station, signaling indicating an indirect assignment of one or more slots for a set of multiple SRS resource sets. The operations of 1405 may be based on identifying time-frequency resources over which the signaling is transmitted, demodulating the signaling over the time-frequency resources, and decoding the demodulated signaling to obtain bits that indicate the indirect assignment. The operations of 1405 may be performed in accordance with examples as disclosed herein. In some examples, aspects of the operations of 1405 may be performed by a signal receiving component 725 as described with reference to FIG. 7.

At 1410, the method may include determining that a first slot of the one or more slots is available for the indirect assignment for at least a first SRS resource set of the set of multiple SRS resource sets based on first characteristics of the first SRS resource set and second characteristics of the first slot. The operations of 1410 may be performed in accordance with examples as disclosed herein. In some examples, aspects of the operations of 1410 may be performed by a slot determining component 730 as described with reference to FIG. 7.

At 1415, the method may include communicating with the base station in the first slot based on determining that the first slot is indicated for the indirect assignment. The operations of 1415 may be performed in accordance with examples as disclosed herein. In some examples, aspects of the operations of 1415 may be performed by a communicating component 735 as described with reference to FIG. 7.

At 1420, the method may include transmitting, in the first slot, a first SRS in the first SRS resource set based on the signaling. The operations of 1420 may be performed in accordance with examples as disclosed herein. In some examples, aspects of the operations of 1420 may be performed by a communicating component 735 as described with reference to FIG. 7.

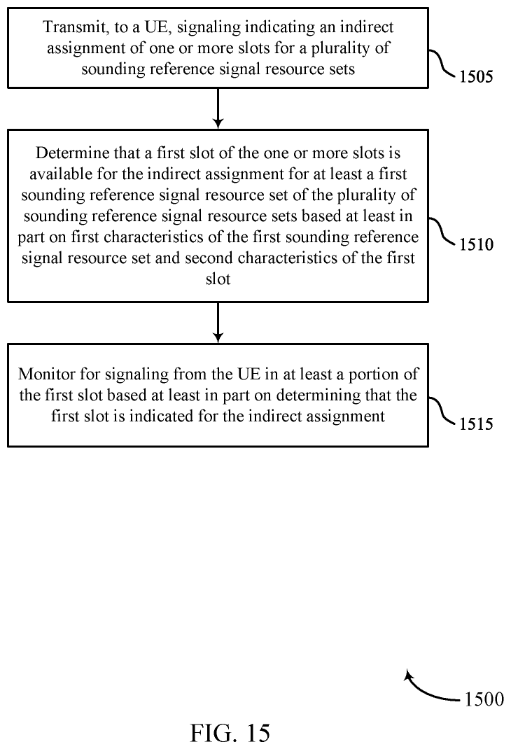

FIG. 15 shows a flowchart illustrating a method 1500 that supports guard periods for SRS resource sets in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally, or alternatively, the base station may perform aspects of the described functions using special-purpose hardware.

At 1505, the method may include transmitting, to a UE, signaling indicating an indirect assignment of one or more slots for a set of multiple SRS resource sets. The operations of 1505 may be performed in accordance with examples as disclosed herein. In some examples, aspects of the operations of 1505 may be performed by a signal transmitting component 1125 as described with reference to FIG. 11.

At 1510, the method may include determining that a first slot of the one or more slots is available for the indirect assignment for at least a first SRS resource set of the set of multiple SRS resource sets based on first characteristics of the first SRS resource set and second characteristics of the first slot. The operations of 1510 may be performed in accordance with examples as disclosed herein. In some examples, aspects of the operations of 1510 may be performed by an availability determining component 1130 as described with reference to FIG. 11.

At 1515, the method may include monitoring for signaling from the UE in at least a portion of the first slot based on determining that the first slot is indicated for the indirect assignment. The operations of 1515 may be performed in accordance with examples as disclosed herein. In some examples, aspects of the operations of 1515 may be performed by a signal monitoring component 1135 as described with reference to FIG. 11.

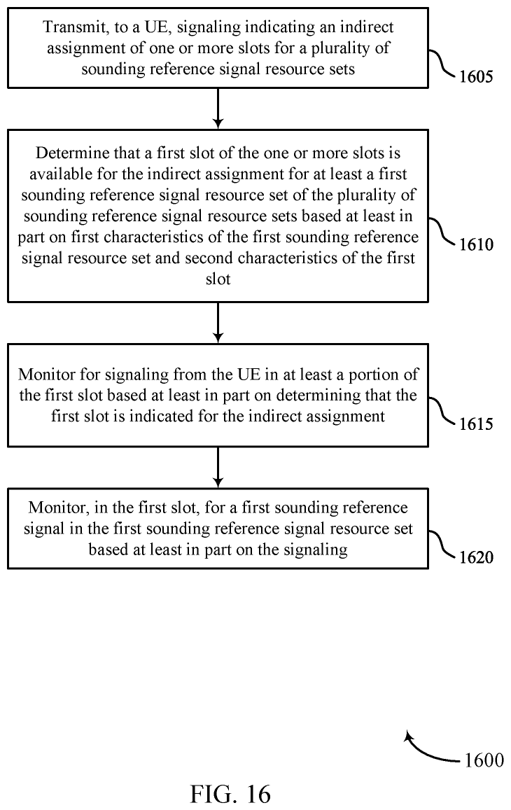

FIG. 16 shows a flowchart illustrating a method 1600 that supports guard periods for SRS resource sets in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally, or alternatively, the base station may perform aspects of the described functions using special-purpose hardware.

At 1605, the method may include transmitting, to a UE, signaling indicating an indirect assignment of one or more slots for a set of multiple SRS resource sets. The operations of 1605 may be performed in accordance with examples as disclosed herein. In some examples, aspects of the operations of 1605 may be performed by a signal transmitting component 1125 as described with reference to FIG. 11.

At 1610, the method may include determining that a first slot of the one or more slots is available for the indirect assignment for at least a first SRS resource set of the set of multiple SRS resource sets based on first characteristics of the first SRS resource set and second characteristics of the first slot. The operations of 1610 may be performed in accordance with examples as disclosed herein. In some examples, aspects of the operations of 1610 may be performed by an availability determining component 1130 as described with reference to FIG. 11.

At 1615, the method may include monitoring for signaling from the UE in at least a portion of the first slot based on determining that the first slot is indicated for the indirect assignment. The operations of 1615 may be performed in accordance with examples as disclosed herein. In some examples, aspects of the operations of 1615 may be performed by a signal monitoring component 1135 as described with reference to FIG. 11.

At 1620, the method may include monitoring, in the first slot, for a first SRS in the first SRS resource set based on the signaling. The operations of 1620 may be performed in accordance with examples as disclosed herein. In some examples, aspects of the operations of 1620 may be performed by a signal monitoring component 1135 as described with reference to FIG. 11.

The following provides an overview of aspects of the present disclosure:
Aspect 1: A method for wireless communications at a UE, comprising: receiving, from a base station, signaling indicating an indirect assignment of one or more slots for a plurality of sounding reference signal resource sets; determining that a first slot of the one or more slots is available for the indirect assignment for at least a first sounding reference signal resource set of the plurality of sounding reference signal resource sets based at least in part on first characteristics of the first sounding reference signal resource set and second characteristics of the first slot; and communicating with the base station in the first slot based at least in part on determining that the first slot is indicated for the indirect assignment.
Aspect 2: The method of aspect 1, wherein communicating with the base station in the first slot comprises: transmitting, in the first slot, a first sounding reference signal in the first sounding reference signal resource set based at least in part on the signaling.
Aspect 3: The method of aspect 2, wherein determining that the first slot is available further comprises: determining that the first slot is available for the indirect assignment based at least in part on maintaining a guard period in the first slot, the guard period associated with the first sounding reference signal resource set and based at least in part on a set of ports associated with the first sounding reference signal.
Aspect 4: The method of any of aspects 2 through 3, further comprising: transmitting a second sounding reference signal in a second sounding reference signal resource set of the plurality of sounding reference signal resource sets based at least in part on the signaling.
Aspect 5: The method of aspect 4, further comprising: maintaining a guard period between the first sounding reference signal resource set and the second sounding reference signal resource set based at least in part on the signaling, a first set of ports associated with the first sounding reference signal, and a second set of ports associated with the second sounding reference signal.
Aspect 6: The method of any of aspects 4 through 5, wherein the second sounding reference signal in the second sounding reference signal resource set is transmitted in the first slot or a second slot of the one or more slots.
Aspect 7: The method of any of aspects 1 through 6, further comprising: determining a quantity of symbols in the first slot, the quantity of symbols comprising uplink symbols, flexible symbols, or both, wherein the second characteristics of the first slot comprise the quantity of symbols.
Aspect 8: The method of aspect 7, further comprising: suppressing transmitting, in the first slot, a first sounding reference signal in the first sounding reference signal resource set based at least in part on the quantity of symbols, a second sounding reference signal resource set of the plurality of sounding reference signal resource sets, a guard period associated with the plurality of sounding reference signal resource sets, a first set of ports associated with the first sounding reference signal, a second set of ports associated with a second sounding reference signal in the second sounding reference signal resource set, or any combination thereof.
Aspect 9: The method of any of aspects 7 through 8, further comprising: transmitting, in the first slot, a first sounding reference signal in the first sounding reference signal resource set based at least in part on the quantity of symbols, the first characteristics of the first sounding reference signal resource set, the second characteristics of the first slot, third characteristics of the signaling, or any combination thereof; and suppressing transmitting a second sounding reference signal in a second sounding reference signal resource set of the plurality of sounding reference signal resource sets based at least in part on the quantity of symbols, the first characteristics of the first sounding reference signal resource set, the second characteristics of the first slot, the third characteristics of the signaling, or any combination thereof.
Aspect 10: The method of aspect 9, wherein the third characteristics of the signaling comprise first control signaling associated with the first sounding reference signal resource set, second control signaling associated with the second sounding reference signal resource set, a first type of the first control signaling, a second type of the second control signaling, or any combination thereof.
Aspect 11: The method of any of aspects 9 through 10, wherein the first characteristics of the first sounding reference signal resource set comprise a first set of ports associated with the first sounding reference signal, an identifier associated with the first sounding reference signal resource set, a quantity of sounding reference signal resources in the first sounding reference signal resource set, a quantity of reference signal symbols in the first sounding reference signal resource set, a transmission power associated with the first sounding reference signal resource set, a reference signal codebook associated with the first sounding reference signal resource set, a frequency sounding configuration associated with the first sounding reference signal resource set, or any combination thereof.
Aspect 12: A method for wireless communications at a base station, comprising: transmitting, to a UE, signaling indicating an indirect assignment of one or more slots for a plurality of sounding reference signal resource sets; determining that a first slot of the one or more slots is available for the indirect assignment for at least a first sounding reference signal resource set of the plurality of sounding reference signal resource sets based at least in part on first characteristics of the first sounding reference signal resource set and second characteristics of the first slot; and monitoring for signaling from the UE in at least a portion of the first slot based at least in part on determining that the first slot is indicated for the indirect assignment.
Aspect 13: The method of aspect 12, wherein monitoring for the signaling from the UE in the at least the portion of the first slot comprises: monitoring, in the first slot, for a first sounding reference signal in the first sounding reference signal resource set based at least in part on the signaling.
Aspect 14: The method of aspect 13, further comprising: suppressing monitoring for the signaling from the UE in a guard period in the first slot based at least in part on the signaling and a set of ports associated with the first sounding reference signal.
Aspect 15: The method of any of aspects 13 through 14, further comprising: monitoring for a second sounding reference signal in a second sounding reference signal resource set of the plurality of sounding reference signal resource sets based at least in part on the signaling.
Aspect 16: The method of aspect 15, further comprising: suppressing monitoring for the signaling from the UE in a guard period between the first sounding reference signal resource set and the second sounding reference signal resource set based at least in part on the signaling, a first set of ports associated with the first sounding reference signal, and a second set of ports associated with the second sounding reference signal.
Aspect 17: The method of any of aspects 15 through 16, wherein monitoring for the second sounding reference signal comprises: monitoring for the second sounding reference signal in the first slot or a second slot of the one or more slots.
Aspect 18: The method of any of aspects 12 through 17, further comprising: determining a quantity of symbols in the first slot, the quantity of symbols comprising uplink symbols, flexible symbols, or both, wherein the second characteristics of the first slot comprise the quantity of symbols.
Aspect 19: The method of aspect 18, further comprising: suppressing monitoring, in the first slot, for a first sounding reference signal in the first sounding reference signal resource set based at least in part on the quantity of symbols, a second sounding reference signal resource set of the plurality of sounding reference signal resource sets, a guard period associated with the plurality of sounding reference signal resource sets, a first set of ports associated with the first sounding reference signal, a second set of ports associated with a second sounding reference signal in the second sounding reference signal resource set, or any combination thereof.
Aspect 20: The method of any of aspects 18 through 19, further comprising: monitoring, in the first slot, for a first sounding reference signal in the first sounding reference signal resource set based at least in part on the quantity of symbols, the first characteristics of the first sounding reference signal resource set, the second characteristics of the first slot, third characteristics of the signaling, or any combination thereof; and suppressing monitoring for a second sounding reference signal in a second sounding reference signal resource set of the plurality of sounding reference signal resource sets based at least in part on the signaling, the quantity of symbols, the first characteristics of the first sounding reference signal resource set, the second characteristics of the first slot, the third characteristics of the signaling, or any combination thereof.
Aspect 21: The method of aspect 20, wherein the third characteristics of the signaling comprise first control signaling associated with the first sounding reference signal resource set, second control signaling associated with the second sounding reference signal resource set, a first type of the first control signaling, a second type of the second control signaling, or any combination thereof.
Aspect 22: The method of any of aspects 20 through 21, wherein the first characteristics of the first sounding reference signal resource set comprise a first set of ports associated with the first sounding reference signal, an identifier associated with the first sounding reference signal resource set, a quantity of reference signal resources in the first sounding reference signal resource set, a quantity of reference signal symbols in the first sounding reference signal resource set, a transmission power associated with the first sounding reference signal resource set, a reference signal codebook associated with the first sounding reference signal resource set, a frequency sounding configuration associated with the first sounding reference signal resource set, or any combination thereof.
Aspect 23: An apparatus for wireless communications at a UE, comprising a processor; memory coupled with the processor; and instructions stored in the memory and executable by the processor to cause the apparatus to perform a method of any of aspects 1 through 11.
Aspect 24: An apparatus for wireless communications at a UE, comprising at least one means for performing a method of any of aspects 1 through 11.
Aspect 25: A non-transitory computer-readable medium storing code for wireless communications at a UE, the code comprising instructions executable by a processor to perform a method of any of aspects 1 through 11.
Aspect 26: An apparatus for wireless communications at a base station, comprising a processor; memory coupled with the processor; and instructions stored in the memory and executable by the processor to cause the apparatus to perform a method of any of aspects 12 through 22.
Aspect 27: An apparatus for wireless communications at a base station, comprising at least one means for performing a method of any of aspects 12 through 22.
Aspect 28: A non-transitory computer-readable medium storing code for wireless communications at a base station, the code comprising instructions executable by a processor to perform a method of any of aspects 12 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. That is, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor:
memory coupled with the processor; and
instructions stored in the memory and executable by the processor to cause the apparatus to:
receive, from a base station, signaling indicating an indirect assignment of one or more slots for a plurality of sounding reference signal resource sets;
determine that a first slot of the one or more slots is available for the indirect assignment for at least a first sounding reference signal resource set of the plurality of sounding reference signal resource sets based at least in part on first characteristics of the first sounding reference signal resource set and second characteristics of the first slot; and
communicate with the base station in the first slot based at least in part on determining that the first slot is indicated for the indirect assignment.

2. The apparatus of claim 1, wherein the instructions to communicate with the base station in the first slot are executable by the processor to cause the apparatus to:
transmit, in the first slot, a first sounding reference signal in the first sounding reference signal resource set based at least in part on the signaling.

3. The apparatus of claim 2, wherein the instructions to determine that the first slot is available are further executable by the processor to cause the apparatus to:
determine that the first slot is available for the indirect assignment based at least in part on maintaining a guard period in the first slot, the guard period associated with the first sounding reference signal resource set and based at least in part on a set of ports associated with the first sounding reference signal.

4. The apparatus of claim 2, wherein the instructions are further executable by the processor to cause the apparatus to:
transmit a second sounding reference signal in a second sounding reference signal resource set of the plurality of sounding reference signal resource sets based at least in part on the signaling.

5. The apparatus of claim 4, wherein the instructions are further executable by the processor to cause the apparatus to:
maintain a guard period between the first sounding reference signal resource set and the second sounding reference signal resource set based at least in part on the signaling, a first set of ports associated with the first sounding reference signal, and a second set of ports associated with the second sounding reference signal.

6. The apparatus of claim 4, wherein the second sounding reference signal in the second sounding reference signal resource set is transmitted in the first slot or a second slot of the one or more slots.

7. The apparatus of claim 1, wherein the instructions are further executable by the processor to cause the apparatus to:
determine a quantity of symbols in the first slot, the quantity of symbols comprising uplink symbols, flexible symbols, or both, wherein the second characteristics of the first slot comprise the quantity of symbols.

8. The apparatus of claim 7, wherein the instructions are further executable by the processor to cause the apparatus to:
suppress transmitting, in the first slot, a first sounding reference signal in the first sounding reference signal resource set based at least in part on the quantity of symbols, a second sounding reference signal resource set of the plurality of sounding reference signal resource sets, a guard period associated with the plurality of sounding reference signal resource sets, a first set of ports associated with the first sounding reference signal, a second set of ports associated with a second sounding reference signal in the second sounding reference signal resource set, or any combination thereof.

9. The apparatus of claim 7, wherein the instructions are further executable by the processor to cause the apparatus to:
transmit, in the first slot, a first sounding reference signal in the first sounding reference signal resource set based at least in part on the quantity of symbols, the first characteristics of the first sounding reference signal resource set, the second characteristics of the first slot, third characteristics of the signaling, or any combination thereof; and
suppress transmitting a second sounding reference signal in a second sounding reference signal resource set of the plurality of sounding reference signal resource sets based at least in part on the quantity of symbols, the first characteristics of the first sounding reference signal resource set, the second characteristics of the first slot, the third characteristics of the signaling, or any combination thereof.

10. The apparatus of claim 9, wherein the third characteristics of the signaling comprise first control signaling associated with the first sounding reference signal resource set, second control signaling associated with the second sounding reference signal resource set, a first type of the first control signaling, a second type of the second control signaling, or any combination thereof.

11. The apparatus of claim 9, wherein the first characteristics of the first sounding reference signal resource set comprise a first set of ports associated with the first sounding reference signal, an identifier associated with the first sounding reference signal resource set, a quantity of sounding reference signal resources in the first sounding reference signal resource set, a quantity of reference signal symbols in the first sounding reference signal resource set, a transmission power associated with the first sounding reference signal resource set, a reference signal codebook associated with the first sounding reference signal resource set, a frequency sounding configuration associated with the first sounding reference signal resource set, or any combination thereof.

12. An apparatus for wireless communications at a base station, comprising:
a processor;
memory coupled with the processor; and
instructions stored in the memory and executable by the processor to cause the apparatus to:
transmit, to a user equipment (UE), signaling indicating an indirect assignment of one or more slots for a plurality of sounding reference signal resource sets;
determine that a first slot of the one or more slots is available for the indirect assignment for at least a first sounding reference signal resource set of the plurality of sounding reference signal resource sets based at least in part on first characteristics of the first sounding reference signal resource set and second characteristics of the first slot; and
monitor for signaling from the UE in at least a portion of the first slot based at least in part on determining that the first slot is indicated for the indirect assignment.

13. The apparatus of claim 12, wherein the instructions to monitor for the signaling from the UE in the at least the portion of the first slot are executable by the processor to cause the apparatus to:
monitor, in the first slot, for a first sounding reference signal in the first sounding reference signal resource set based at least in part on the signaling.

14. The apparatus of claim 13, wherein the instructions are further executable by the processor to cause the apparatus to:
suppress monitoring for the signaling from the UE in a guard period in the first slot based at least in part on the signaling and a set of ports associated with the first sounding reference signal.

15. The apparatus of claim 13, wherein the instructions are further executable by the processor to cause the apparatus to:
monitor for a second sounding reference signal in a second sounding reference signal resource set of the plurality of sounding reference signal resource sets based at least in part on the signaling.

16. The apparatus of claim 15, wherein the instructions are further executable by the processor to cause the apparatus to:
suppress monitoring for the signaling from the UE in a guard period between the first sounding reference signal resource set and the second sounding reference signal resource set based at least in part on the signaling, a first set of ports associated with the first sounding reference signal, and a second set of ports associated with the second sounding reference signal.

17. The apparatus of claim 15, wherein the instructions to monitor for the second sounding reference signal are executable by the processor to cause the apparatus to:
monitor for the second sounding reference signal in the first slot or a second slot of the one or more slots.

18. The apparatus of claim 12, wherein the instructions are further executable by the processor to cause the apparatus to:
determine a quantity of symbols in the first slot, the quantity of symbols comprising uplink symbols, flexible symbols, or both, wherein the second characteristics of the first slot comprise the quantity of symbols.

19. The apparatus of claim 18, wherein the instructions are further executable by the processor to cause the apparatus to:
suppress monitoring, in the first slot, for a first sounding reference signal in the first sounding reference signal resource set based at least in part on the quantity of symbols, a second sounding reference signal resource set of the plurality of sounding reference signal resource sets, a guard period associated with the plurality of sounding reference signal resource sets, a first set of ports associated with the first sounding reference signal, a second set of ports associated with a second sounding reference signal in the second sounding reference signal resource set, or any combination thereof.

20. The apparatus of claim 18, wherein the instructions are further executable by the processor to cause the apparatus to:
monitor, in the first slot, for a first sounding reference signal in the first sounding reference signal resource set based at least in part on the quantity of symbols, the first characteristics of the first sounding reference signal resource set, the second characteristics of the first slot, third characteristics of the signaling, or any combination thereof; and
suppress monitoring for a second sounding reference signal in a second sounding reference signal resource set of the plurality of sounding reference signal resource sets based at least in part on the signaling, the quantity of symbols, the first characteristics of the first sounding reference signal resource set, the second characteristics of the first slot, the third characteristics of the signaling, or any combination thereof.

21. The apparatus of claim 20, wherein the third characteristics of the signaling comprise first control signaling associated with the first sounding reference signal resource set, second control signaling associated with the second sounding reference signal resource set, a first type of the first control signaling, a second type of the second control signaling, or any combination thereof.

22. The apparatus of claim 20, wherein the first characteristics of the first sounding reference signal resource set comprise a first set of ports associated with the first sounding reference signal, an identifier associated with the first sounding reference signal resource set, a quantity of reference signal resources in the first sounding reference signal resource set, a quantity of reference signal symbols in the first sounding reference signal resource set, a transmission power associated with the first sounding reference signal resource set, a reference signal codebook associated with the first sounding reference signal resource set, a frequency sounding configuration associated with the first sounding reference signal resource set, or any combination thereof.

23. A method for wireless communications at a user equipment (UE), comprising:
receiving, from a base station, signaling indicating an indirect assignment of one or more slots for a plurality of sounding reference signal resource sets;
determining that a first slot of the one or more slots is available for the indirect assignment for at least a first sounding reference signal resource set of the plurality of sounding reference signal resource sets based at least in part on first characteristics of the first sounding reference signal resource set and second characteristics of the first slot; and
communicating with the base station in the first slot based at least in part on determining that the first slot is indicated for the indirect assignment.

24. The method of claim 23, wherein communicating with the base station in the first slot comprises:
transmitting, in the first slot, a first sounding reference signal in the first sounding reference signal resource set based at least in part on the signaling.

25. The method of claim 24, wherein determining that the first slot is available further comprises:
determining that the first slot is available for the indirect assignment based at least in part on maintaining a guard period in the first slot, the guard period associated with the first sounding reference signal resource set and based at least in part on a set of ports associated with the first sounding reference signal.

26. The method of claim 24, further comprising:
transmitting a second sounding reference signal in a second sounding reference signal resource set of the plurality of sounding reference signal resource sets based at least in part on the signaling.

27. A method for wireless communications at a base station, comprising:
transmitting, to a user equipment (UE), signaling indicating an indirect assignment of one or more slots for a plurality of sounding reference signal resource sets;
determining that a first slot of the one or more slots is available for the indirect assignment for at least a first sounding reference signal resource set of the plurality of sounding reference signal resource sets based at least in part on first characteristics of the first sounding reference signal resource set and second characteristics of the first slot; and
monitoring for signaling from the UE in at least a portion of the first slot based at least in part on determining that the first slot is indicated for the indirect assignment.

28. The method of claim 27, wherein monitoring for the signaling from the UE in the at least the portion of the first slot comprises:
monitoring, in the first slot, for a first sounding reference signal in the first sounding reference signal resource set based at least in part on the signaling.

29. The method of claim 28, further comprising:
suppressing monitoring for the signaling from the UE in a guard period in the first slot based at least in part on the signaling and a set of ports associated with the first sounding reference signal.

30. The method of claim 28, further comprising:
monitoring for a second sounding reference signal in a second sounding reference signal resource set of the plurality of sounding reference signal resource sets based at least in part on the signaling.
